(19) United States
(12) Patent Application Publication
(10) Pub. No.: US 2025/0356590 A1
(43) Pub. Date: Nov. 20, 2025

(54) SIMPLIFYING TRIANGLE MESHES

(71) Applicant: Roblox Corporation, San Mateo, CA (US)

(72) Inventors: Hsueh-Ti Derek LIU, Vancouver (CA); Xiaoting ZHANG, San Mateo, CA (US); Cem YUKSEL, San Mateo, CA (US)

(73) Assignee: Roblox Corporation, San Mateo, CA (US)

(21) Appl. No.: 19/200,020

(22) Filed: May 6, 2025

Related U.S. Application Data
(60) Provisional application No. 63/647,788, filed on May 15, 2024.

(51) Int. Cl. G06T 17/20; G06T 15/04

(52) U.S. Cl. CPC G06T 17/205; G06T 15/04

(57) ABSTRACT

Mesh simplification reduces the complexity of 3D objects while maintaining visual fidelity. While there are effective techniques for mesh simplification for simple meshes, in actual use cases it may be difficult to simplify more complicated meshes. A technical solution retrieves an initial mesh (e.g. a triangle mesh) and constructs an edge list including physical and virtual edges for the initial mesh. The initial mesh is then decimated by iteratively collapsing the edges, prioritized based on a modified quadric error metric that may combine a memory edge quadric error and a memoryless area quadric error. The technical solution may maintain a correspondence map during the decimating and use it to perform texture transfer after simplification based on the correspondence map.

### CROSS-REFERENCE TO RELATED APPLICATIONS

This application claims priority to U.S. Provisional Application No. 63/647,788, entitled “SIMPLIFYING TRIANGLE MESHES,” filed on May 15, 2024, the content of which is incorporated herein in its entirety.

### TECHNICAL FIELD

This disclosure relates generally to computer graphics, and more particularly but not exclusively, relates to methods, systems, and computer readable media to simplify triangle meshes.

### BACKGROUND

Mesh simplification reduces the complexity of 3D objects (e.g., computational work required to be performed to render the object for display, including object state such as orientation, object attributes such as texture, etc.) while maintaining visual fidelity of the 3D objects for display purposes. These techniques play a role in interactive graphics to deliver high-quality content under a limited computation budget, such as when the interactive graphics required 3D objects to be rendered in real-time, e.g., in games, virtual experiences, and other contexts.

Existing solutions are primarily designed for simplifying meshes such as manifold meshes having a single connected component. Existing techniques exhibit excellent results on this type of input. Unfortunately, triangle meshes in real-world use cases rarely fall into this category of input. Meshes encountered in practice often have multiple disjoint components with non-manifold structures coming from, for example, architecture models. Directly applying existing techniques often fails to exhibit high-quality simplification results for such meshes.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to simplify triangle meshes is provided, the method comprising: retrieving an initial triangle mesh; constructing an edge list for the initial triangle mesh, wherein the edge list includes physical edges and virtual edges; decimating the initial triangle mesh to generate a simplified triangle mesh by iteratively collapsing the edges in the edge list, the collapsing being prioritized by a quadric error metric based on a combination of an edge quadric error and an area quadric error, wherein the decimating comprises maintaining a correspondence map between points on the simplified triangle mesh and corresponding points on the initial triangle mesh; and after the decimating, performing texture transfer based on the correspondence map to generate a texture image for the simplified triangle mesh.

Various implementations of the computer-implemented method are described herein.

In some implementations, the initial triangle mesh corresponds to a three-dimensional (3D) virtual object in a virtual experience, and wherein the initial triangle mesh is associated with a texture used to generate the texture image, with a correspondence between the initial triangle mesh and the texture being stored as a UV map.

In some implementations, the method further comprises, after performing the texture transfer: applying the texture image to the simplified triangle mesh; and after the applying, causing the 3D virtual object to be displayed in the virtual experience.

In some implementations, performing the texture transfer comprises, for each point on the texture image: identifying a point on the simplified triangle mesh associated with the point on the texture image; finding, based on the correspondence map, a corresponding point on the initial triangle mesh corresponding to the point on the simplified triangle mesh; and sampling color information at the corresponding point on the initial triangle mesh to determine a color for the point on the texture image.

In some implementations, constructing the edge list comprises defining the virtual edges by: measuring triangle-to-triangle distances between triangles in the initial triangle mesh by identifying closest points for each pair of triangles in the initial triangle mesh; determining that a distance between the closest points for the pair of triangles is less than a threshold; determining that the closest points are not from same connected components for the pair of triangles; and in response to determining that the distance is less than the threshold and the closest points are not from the same connected components, forming a virtual edge between a vertex pair that is closest to the closest points for the pair of triangles.

In some implementations, the method further comprises, after constructing the edge list, combining the edge list with initial vertices and triangles of the initial triangle mesh to form a simplicial complex.

In some implementations, the iteratively collapsing uses greedy edge collapses to simplify a connectivity of the simplicial complex.

In some implementations, collapsing an edge comprises: merging a pair of vertices connected by the edge into a new vertex; and updating the edges and faces connected to the pair of vertices by replacing references to each vertex in the pair of vertices with references to the new vertex.

In some implementations, the method further comprises performing validity checks and rejecting edges that violate the validity checks.

According to another aspect, a non-transitory computer-readable medium is provided. The non-transitory computer-readable medium with instructions stored thereon that, responsive to execution by a processing device, causes the processing device to perform operations comprising: retrieving an initial triangle mesh; constructing an edge list for the initial triangle mesh, wherein the edge list includes physical edges and virtual edges; decimating the initial triangle mesh to generate a simplified triangle mesh by iteratively collapsing the edges in the edge list, the collapsing being prioritized by a quadric error metric based on a combination of an edge quadric error and an area quadric error, wherein the decimating comprises maintaining a correspondence map between points on the simplified triangle mesh and corresponding points on the initial triangle mesh; and after the decimating, performing texture transfer based on the correspondence map to generate a texture image for the simplified triangle mesh.

Various implementations of the non-transitory computer-readable medium are described herein.

In some implementations, performing the texture transfer comprises, for each point on the texture image: identifying a point on the simplified triangle mesh associated with the point on the texture image; finding, based on the correspondence map, a corresponding point on the initial triangle mesh corresponding to the point on the simplified triangle mesh; and sampling color information at the corresponding point on the initial triangle mesh to determine a color for the point on the texture image.

In some implementations, constructing the edge list comprises defining the virtual edges by: measuring triangle-to-triangle distances between triangles in the initial triangle mesh by identifying closest points for each pair of triangles in the initial triangle mesh; determining that a distance between the closest points for the pair of triangles is less than a threshold; determining that the closest points are not from same connected components for the pair of triangles; and in response to determining that the distance is less than the threshold and the closest points are not from the same connected components, forming a virtual edge between a vertex pair that is closest to the closest points for the pair of triangles.

In some implementations, the operations further comprise, after constructing the edge list, combining the edge list with initial vertices and triangles of the initial triangle mesh to form a simplicial complex.

In some implementations, the iteratively collapsing uses greedy edge collapses to simplify a connectivity of the simplicial complex.

In some implementations, collapsing an edge comprises: merging a pair of vertices connected by the edge into a new vertex; and updating the edges and faces connected to the pair of vertices by replacing references to each vertex in the pair of vertices with references to the new vertex.

According to another aspect, a system is disclosed, comprising: a memory with instructions stored thereon; and a processing device, coupled to the memory, the processing device configured to access the memory, wherein the instructions when executed by the processing device cause the processing device to perform operations comprising: retrieving an initial triangle mesh; constructing an edge list for the initial triangle mesh, wherein the edge list includes physical edges and virtual edges; decimating the initial triangle mesh to generate a simplified triangle mesh by iteratively collapsing the edges in the edge list, the collapsing being prioritized by a quadric error metric based on a combination of an edge quadric error and an area quadric error, wherein the decimating comprises maintaining a correspondence map between points on the simplified triangle mesh and corresponding points on the initial triangle mesh; and after the decimating, performing texture transfer based on the correspondence map to generate a texture image for the simplified triangle mesh.

Various implementations of the system are described herein.

In some implementations, performing the texture transfer comprises, for each point on the texture image: identifying a point on the simplified triangle mesh associated with the point on the texture image; finding, based on the correspondence map, a corresponding point on the initial triangle mesh corresponding to the point on the simplified triangle mesh; and sampling color information at the corresponding point on the initial triangle mesh to determine a color for the point on the texture image.

In some implementations, constructing the edge list comprises defining the virtual edges by: measuring triangle-to-triangle distances between triangles in the initial triangle mesh by identifying closest points for each pair of triangles in the initial triangle mesh; determining that a distance between the closest points for the pair of triangles is less than a threshold; determining that the closest points are not from same connected components for the pair of triangles; and in response to determining that the distance is less than the threshold and the closest points are not from the same connected components, forming a virtual edge between a vertex pair that is closest to the closest points for the pair of triangles.

In some implementations, the operations further comprise, after constructing the edge list, combining the edge list with initial vertices and triangles of the initial triangle mesh to form a simplicial complex.

In some implementations, the iteratively collapsing uses greedy edge collapses to simplify a connectivity of the simplicial complex.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is an example of simplifying a city scene, in accordance with some implementations.

FIG. 2A is a flowchart illustrating an example method of simplifying a triangle mesh, in accordance with some implementations.

FIG. 2B is a flowchart illustrating an example method of determining color information for corresponding points using a correspondence map, in accordance with some implementations.

FIG. 2C is a flowchart illustrating an example method of identifying virtual edges and using the virtual edges to simplify a triangle mesh, in accordance with some implementations.

FIG. 2D is a flowchart illustrating an example method of merging vertices, in accordance with some implementations.

FIG. 3A is a diagram illustrating using vertex quadrics, in accordance with some implementations.

FIG. 3B is a diagram illustrating using area quadrics, in accordance with some implementations.

FIG. 3C is a diagram illustrating a physical edge and a virtual edge, in accordance with some implementations.

FIG. 3D is a diagram illustrating vertex pair collapses, in accordance with some implementations.

FIG. 3E is a diagram illustrating area loss, in accordance with some implementations.

FIG. 3F is a diagram illustrating a vertex split and closest points, in accordance with some implementations.

FIG. 4A is a diagram illustrating using techniques in various difficult use cases, in accordance with some implementations.

FIG. 4B is a diagram illustrating techniques that simplify an initial mesh while preserving interior structures of a 3D object, in accordance with some implementations.

FIG. 5A is a diagram illustrating using virtual edges based on triangle distances, in accordance with some implementations.

FIG. 5B is a diagram illustrating techniques to avoid deleting geometrically significant parts of an initial mesh by penalizing collapses that introduce significant area change, in accordance with some implementations.

FIG. 6 is a diagram illustrating techniques to simplify a triangle mesh that use a modified quadric error metric to preserve sharp geometric features, in accordance with some implementations.

FIG. 7 is a diagram illustrating techniques to simplify a triangle mesh that avoid texture bleeding, in accordance with some implementations.

FIG. 8 is an additional diagram illustrating techniques to simplify a triangle mesh that avoid texture bleeding, in accordance with some implementations.

FIG. 9 is a diagram illustrating successive stages of simplifying a triangle mesh, in accordance with some implementations.

FIG. 10 is a diagram illustrating techniques to improve projections, in accordance with some implementations.

FIG. 11 is a diagram illustrating techniques to repair a triangle mesh, in accordance with some implementations.

FIG. 12 is a diagram illustrating comparing techniques to alternative techniques, in accordance with some implementations.

FIG. 13 is a diagram illustrating techniques to manage a single connected rigid object, with a complicated shape, in accordance with some implementations.

FIG. 14 is a diagram illustrating techniques to regenerate UV-coordinates, in accordance with some implementations.

FIG. 15 is a diagram of an example system architecture that includes a 3D environment platform to simplify triangle meshes, in accordance with some implementations.

FIG. 16 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

The present disclosure is directed towards, inter alia, simplifying triangle meshes. For example, there may be a 3D object that is constructed of a set of meshes and a texture mapped to the triangle mesh or meshes (e.g., such that the 3D object can be rendered for display by layering the texture on the set of meshes). Rendering the 3D object involves computation, which may be expensive. The cost for this computation can be lowered by simplifying the triangle mesh or meshes. Such simplifying is performed to retain the ability to successfully apply the texture to the simplified mesh to render the 3D object.

In some implementations, to perform the simplification, a triangle mesh is retrieved. An edge list is constructed for the retrieved triangle mesh. The edge list is iteratively collapsed to decimate the triangle mesh. During the decimation, physical edges (edges obtained from faces) and virtual edges (edges that do not actually exist in the face list) are prioritized based on a modified quadric error metric including a memory edge quadric error and/or a memoryless area quadric error. During the decimation, a correspondence map is maintained that permits effective texture transfer thereafter.

Mesh simplification reduces the complexity of three-dimensional (3D) objects while trying to maintain the visual fidelity of the 3D objects. Mesh simplification plays a fundamental role in interactive graphics techniques and environments. The mesh simplification permits the techniques and environments to deliver high-quality content under conditions of limited computation budget (e.g., limited processing resources, memory resources, etc.). For example, rendering at real-time frame rates limits available computation budget, in that computational resources are supplied at a set rate in real-time applications. The importance of mesh simplification has led to the development of various techniques over the past few decades to successfully perform mesh simplification.

Existing solutions are primarily designed for manifold meshes of single connected components. Existing techniques provide excellent results on this type of inputs, but unfortunately triangle meshes in real-life use cases rarely fall into this category. Meshes encountered in practice often have multiple disjoint components with non-manifold structures. Directly applying existing techniques often fails to provide high-quality simplification results.

Various mathematical techniques and definitions provide context for the techniques introduced herein.

The quadric error metric is defined on 2-manifold surfaces. Let p∈M be a point on a surface M embedded in [symbol] and \hat{n} be the (unit) normal vector at p. The tangent plane at p is given by all points x∈ [symbol] that satisfy \hat{n}^{T}(x−p)=0. The quadric error E(x) measures the squared distance from any point x to the tangent plane at p, which can be computed as E(x)=(\hat{n}^{T}(x−p))²=(x−p)^{T}\hat{n}\hat{n}^{T}(x−p)=x^{T}Ax+2b^{T}x+c, with A=\hat{n}\hat{n}^{T}, b=−Ap, c=p^{T}Ap.

A quadric Q refers to the triplet (A, b, c) which are quantities derived by the plane equation P with a unit normal \hat{n} and a point p on the tangent plane: Q:=(A, b, c)=P(\hat{n}, p). This quadric Q provides sufficient information to compute the quadric error E (x).

The quadric error can be generalized to triangulated 2-manifolds by the defining the quadric error Eᵢⱼₖ on the plane of each triangle ijk.

$${E}_{ijk} ( x ) = {x}^{T} {A}_{ijk} x + 2 {b}_{ijk}^{T} + {c}_{ijk}$$

with parameters defined by the triangle quadric Qᵢⱼₖ, Qᵢⱼₖ=(Aᵢⱼₖ, bᵢⱼₖ, cᵢⱼₖ)=P(nᵢⱼₖ, vᵢ) derived from the face normal nᵢⱼₖ and one of its corner vertex locations, such as vᵢ.

For each vertex i, the vertex quadric error Eᵢ is defined as the weighted summation of the triangle quadric errors Eᵢⱼₖ from its one-ring triangles ijk.

$${E}_{i} ( x ) = {\sum }_{ijk ∈ {N}_{i}} {a}_{i j k}^{i} {E}_{ijk} ( x ) = {\sum }_{ijk ∈ {N}_{i}} {a}_{ijk}^{i} ( {x}^{T} {A}_{ijk} x + 2 {b}_{ijk}^{T} + {c}_{ijk} ) = {x}^{T} ( {\sum }_{ijk ∈ {N}_{i}} {A}_{ijk} x ) x + 2 ( {\sum }_{ijk ∈ {N}_{i}} {a}_{ijk}^{i} {b}_{ijk}^{T} ) x + ( {\sum }_{ijk ∈ {N}_{i}} {a}_{ijk}^{i} {c}_{ijk} ) .$$

As used herein, Nᵢ denotes the one-ring triangles of the vertex i and aᵢⱼₖⁱ is a portion of the vertex area at i coming from face ijk. A common choice of area is the barycentric area that simply sets aᵢⱼₖⁱ=aᵢⱼₖ/3 to be one-third of the face area aᵢⱼₖ. This derivation gives rise to the definition of vertex quadric Qᵢ as a weighted summation of its one-ring triangle quadrics Qᵢⱼₖ, Qᵢ=Σ_{ijk∈N}_{ᵢ}aᵢⱼₖⁱQᵢⱼₖ where the summation between quadrics is the component-wise summation for all elements int the triplets.

The quadric error metric Eᵢⱼ=for each edge ij is defined as a summation of vertex quadric errors of is endpoints Eᵢⱼ=Eᵢ(x)+Eⱼ(x). Because summing up quadric errors leads to a summation of quadrics, this leads to the definition of an edge quadric Qᵢⱼ as Qᵢⱼ=Qᵢ(x)+Qⱼ(x).

In some approaches, simplifying a triangle mesh may occur by iteratively collapsing the edge with the smallest edge quadratic error. Once the edge quadric Qᵢⱼ is obtained, the cost of collapsing the edge is the smallest edge quadric error Eᵢⱼ(x*) evaluated at optimal location x*. Let Qᵢⱼ=(Aᵢⱼ, bᵢⱼ, cᵢⱼ). Then, the optimal location x* can be computed by solving a linear system obtained from setting ∇Eᵢⱼ=0; AᵢⱼX*=−bᵢⱼ.

If the matrix Auf is invertible and well-conditioned (i.e., its inverse can be computed with good accuracy), one can solve the linear system using various linear solvers, such as Cholesky decomposition (a decomposition of a Hermitian, positive-definite matrix into the product of a lower triangular matrix and its conjugate transpose, which is useful for efficient numerical solutions).

Otherwise, it may be possible to use the singular value decomposition to solve for x* more robustly. In subsequent iterations, instead of recomputing the edge quadric, it may be possible to use Qᵢⱼ as the vertex quadric for the newly inserted vertex. If an edge ij is collapsed to a vertex i′, the quadric of the new vertex Qᵢ′=Qᵢⱼ is simply the edge quadric before the collapse. Qᵢ′ is then used to update the quadrics for its one-ring edges. This definition permits the quadric error to memorize all the plane information on the input mesh instead of just the current mesh.

In practice, compared to recomputing the edge quadric Qᵢⱼ from scratch, such an accumulation can lead to a more efficient and high-quality decimation. Some applications may favor not accumulating quadrics.

In this disclosure, the term “memory” denotes an implementation that accumulates the quadric effort metric throughout the decimation. The term “memoryless” denotes an implementation that recomputes the quadric at every iteration.

The quadric error metric is the basis of several variants to serve different purposes. Among them, the area quadric is related to the decimation metric. The area quadric measures the squared area change for each edge collapse.

The squared area change for each edge ij can be written as a quadratic expression, thus giving birth to the area quadric

$${Q}_{ij}^{A} , {Q}_{ij}^{A} = {\sum }_{ab ∈ {N}_{ij} ∩ \partial M} ( {{[ {s}_{ab} ]}_{x}^{T} [ {s}_{ab} ]}_{x} , - {[ {s}_{a b} ]}_{x} {t}_{ab} , {t}_{ab}^{T} {t}_{ab} ) / 2$$

with s_{ab}=v_{b}−vₐ, t_{ab}=vₐ×v_{b}, where ab are ij's one-ring edges that are also on the mesh boundary ∂M and [⋅]ₓ is the cross product matrix defined as

$${[ x ]}_{x} : = [ \begin{matrix}0 & - {x}_{2} & {x}_{1} \\ {x}_{2} & 0 & - {x}_{0} \\ - {x}_{1} & {x}_{0} & 0\end{matrix} ]$$

This area quadric

$${Q}_{ij}^{A}$$

is derived from summing up the squared area (computed with cross products) from each boundary edge ab to the newly insertex vertex i′. This result implies that this area quadric is merely an approximation to the actual area change. The measure ignores the cancelation between the area gain and the loss. The proxy maintains the favorable quadratic expression and can be seamlessly incorporated into the quadric-based mesh simplification.

Various implementations provide an improved mesh simplification system that can robustly simplify textured triangle meshes in real-life use cases. Such real-life use cases may include meshes with multiple components, non-manifolds, and even the difficult case of triangle soups. Triangle soups refer to a collection of unorganized triangles that represent a 3D object without any defined connectivity information between the triangles.

Some implementations begin with approaches based on alternative edge collapse techniques with quadric error metrics. The present techniques propose modifications and extensions of such edge collapse techniques by using specific quadric error metrics that generalize these techniques to handle non-manifold meshes with multiple components.

Given a triangle mesh, an edge list is constructed that includes both physical edges obtained from faces and virtual edges that do not exist in the face list. Once the edge list is constructed, the mesh is decimated by iteratively collapsing each physical or virtual edge prioritized by a modified quadric error metric. The modified quadric error metric used in some implementations is a combination of the memory edge quadric and the memoryless area quadric errors.

During decimation, a correspondence map is maintained. Such a correspondence map associates portions of the simplified mesh with corresponding portions of the initial mesh. The described techniques also permit texture transfer after simplification. The results demonstrate the effectiveness of the techniques in simplifying triangle meshes in real-life use cases.

The techniques described use local decimation defined on triangle meshes to preserve the geometric appearance of the triangle meshes. The techniques presented herein simplify a triangle mesh by iterative edge collapses. In some implementations, the sequence of edge collapses is determined based on a modified quadric error metric.

Implementations provide a mesh simplification technique that can robustly simplify triangle meshes in the real world, including meshes with multiple components, non-manifolds, and even the difficult case of triangle soups (an unorganized set of triangles).

Implementations simplify triangle meshes by performing vertex pair collapses. Such vertex pair collapses provide a way to progressively simplify an initial triangle mesh. After retrieving an initial triangle mesh, an edge list of physical and virtual edges is constructed based on the triangle mesh. For example, virtual edges may be constructed based on triangle-to-triangle distances to measure whether components are co-located.

After constructing the edge list with the physical edges and the virtual edges, combining the edge list with the initial vertices and triangle lists (e.g., from the input) forms a simplicial 2-complex. A simplicial 2-complex refers to a structured set composed of points, line segments, and triangles, called simplices, such that all the faces, edges, vertices are included in the set.

The simplicial complex used in the techniques may be represented as a list of lists. Such a list of lists stores information used to perform the techniques in a data structure designed to represent the simplicial complex in a manner that manages resources effectively.

Some implementations may use greedy edge collapses to simplify the connectivity of the simplicial complex. Such collapses provide for removal of degenerate and duplicate vertices. Such removal can simplify the underlying mesh. In some implementations, validity checks may be optional, based on whether one wants to preserve the mesh topology.

In some implementations, an error metric may indicate ways to perform a greedy edge collapse, such that each edge collapse collapses an edge that leads to the greatest decrease in the error metric.

An aspect of successful mesh simplification (e.g., mesh simplification that reduces the number of triangles while managing error effectively) is to define an error metric that prioritizes the sequences of edge collapses. Using an edge quadric is effective for single manifold triangle meshes. Using an edge quadric alone can cause problems when decimating meshes with multiple components.

To manage the issue of problems that occur when decimating meshes with multiple components, some implementations use a particular version of a quadric error metric. Such a particular quadric error metric includes a combination of the edge quadric with memory and the area quadric without memory for boundary edges. Using this combined approach manages areas of using these approaches separately, resulting in excellent performance (e.g., a substantial decrease in triangle count without a serious degradation in the representative aspects of the triangle mesh).

Some implementations permit texture transfer using successive mapping. Many meshes used in use case have associated textures. In techniques, it may be relevant to consider attribute transfer to perform mesh simplification. UV coordinates are commonly used to store the mapping to a texture space that stores the surface attribute information.

UV mapping is the 3D modeling process of projecting a 3D model's surface to a 2D image for texture mapping. The letters “U” and “V” denote the axes of the 2D texture because “X”, “Y”, and “Z” are already used to denote the axes of the 3D object in model space, while “W” (in addition to XYZ) is used in calculating quaternion rotations, a common operation in computer graphics.

An approach to preserving mesh textures is to preserve UV coordinates. By preserving UV coordinates, it may be possible to preserve texture information of the meshes. In some implementations, an approach of computing a map from a simplified model to the initial model using a combination of successive mappings and progressive simplicial complexes is utilized.

Some implementations benefit from the efficiency of using a greedy edge collapse approach. Because of such efficiency, techniques permit fast mesh simplification in nearly linear time for low-resolution meshes. The techniques provided herein provide an improvement over previous approaches in result quality. This improvement may be achieved because the techniques discussed herein prioritize merging disconnected components. The techniques also avoid deleting components with a large surface area.

In some implementations, the techniques are further augmented to transfer texture even if the mesh is non-manifold with multiple components. The techniques can also avoid the texture bleeding issue that many UV-preserving simplification approaches suffer. Texture bleeding is the effect of color values of adjacent pixels in the UV-map/texture “bleed over” in your polygon. Texture bleeding may appear when the mesh boundary in the UV-map alters. Particular ways to avoid texture bleeding are discussed herein.

The techniques presented herein can successfully simplify models (3D objects) down to a very low resolution (e.g., 0.1% of their original resolution) when the input resolution is sufficiently large. In addition to robustness, the techniques lead to smaller geometric errors after simplification. For example, such geometric errors may be measured by the Hausdorff distance and the mean squared Chamfer distances.

The Hausdorff distance, or Hausdorff metric measures how far two subsets of a metric space are from each other. The Hausdorff distance turns the set of non-empty compact subsets of a metric space into a metric space in its own right.

The Chamfer distance is a metric used to evaluate the similarity between two sets of points. Given two point sets A and B, the Chamfer distance is defined as the sum of the distances from each point in A to its nearest neighbor in B, plus the sum of the distances from each point in B to its nearest neighbor in A. The Chamfer distance is used in a variety of applications, including computer vision, robotics, and computer graphics. The techniques push the robustness of mesh simplification to handle any triangle meshes, including non-manifolds and ones with multiple connected components.

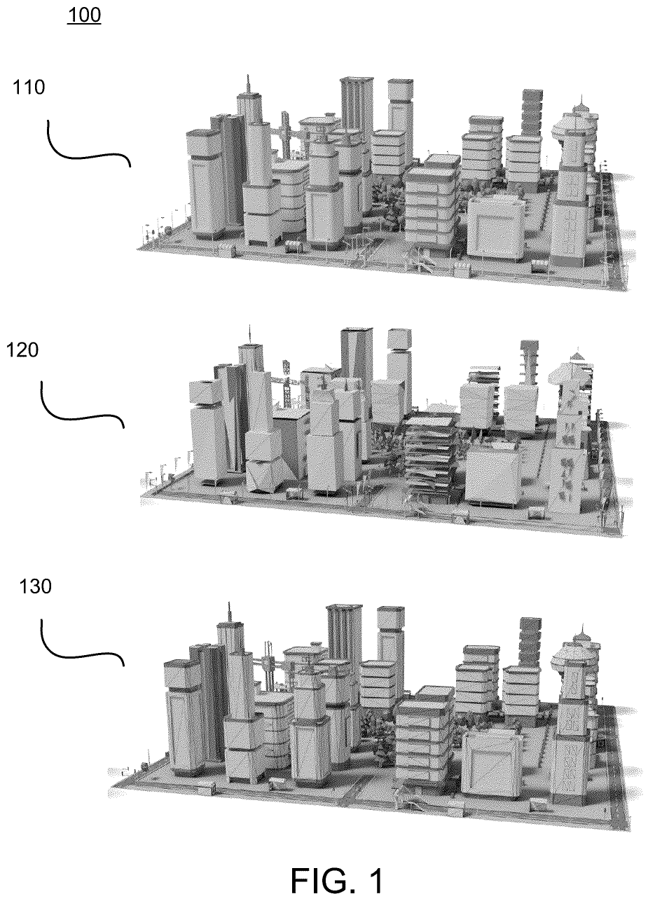

FIG. 1 is an example of simplifying a city scene 100, in accordance with some implementations. FIG. 1 illustrates an initial triangle mesh 110. In order to simplify the initial triangle mesh 110, various techniques may be used. Given a city scene in a real-life use case, it may be useful to simplify the mesh down to a fraction of its original resolution, such as 10% of its original resolution.

One alternative technique may provide a simplification using an alternative quadric error metric to provide simplified triangle mesh 120. Some techniques as disclosed herein may provide an alternative simplification, providing simplified triangle mesh 130. The techniques disclosed herein better preserve geometrically significant components (e.g., buildings) in simplified triangle mesh 130 compared to the simplified triangle mesh 120 generated using quadric error simplification, which prioritizes small components (e.g., streetlamps). Prioritizing small components may interfere with preserving geometric structures that play a larger role in the quality of the simplified triangle mesh.

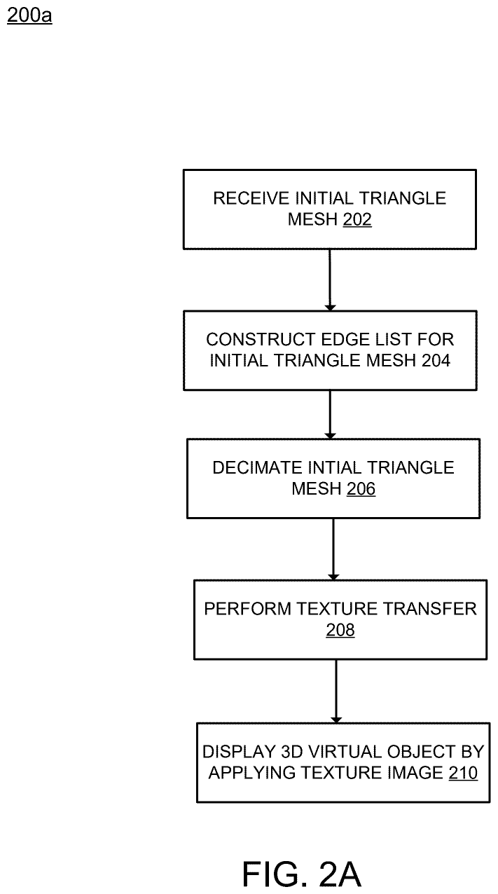

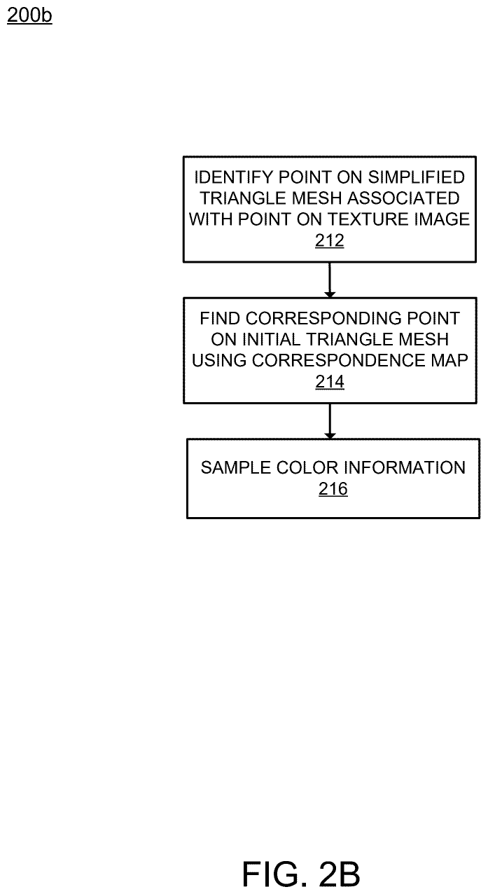

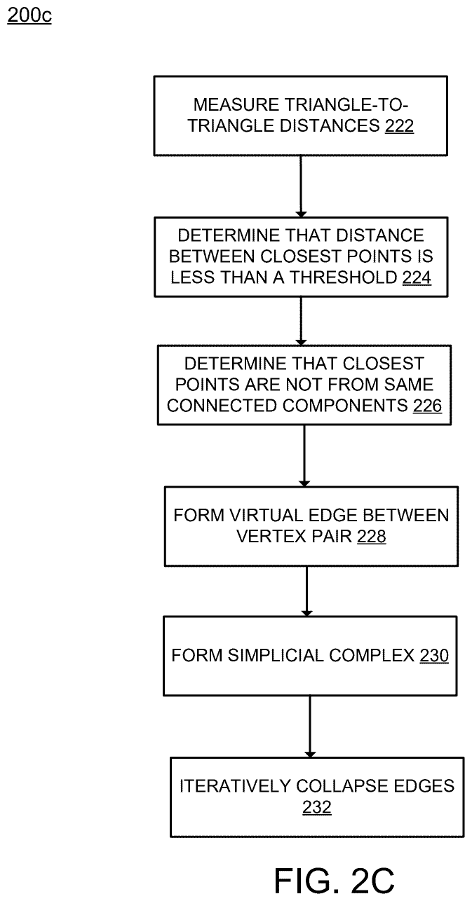

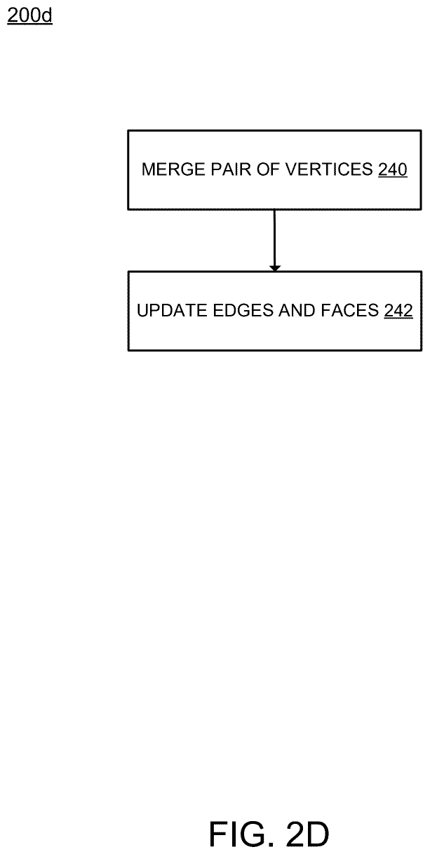

FIG. 2A is a flowchart illustrating an example method 200a of simplifying a triangle mesh, in accordance with some implementations. Method 200a may begin at block 202.

At block 202, an initial triangle mesh is received. Such an initial triangle mesh may have more triangles (i.e., a larger triangle count) than a triangle count in a target simplified triangle mesh. For example, the initial triangle mesh may define a three-dimensional (3D) object. Such a 3D object may be an avatar or another asset in a virtual environment.

One characteristic of initial triangle meshes simplified by techniques disclosed herein is that the initial triangle meshes may have characteristics that cause the initial triangle meshes to be difficult to simplify while preserving certain geometric characteristics of the triangle mesh. For example, the initial triangle mesh may be obtained from a noisy 3D scan, may be based on low-quality triangles from computer-aided design (CAD) models, and/or may involve meshes with defects or other aspects that are difficult to simplify, such as multiple components, self-intersections, and/or non-manifolds. Techniques provide ways to perform mesh simplification in such cases, which alternative techniques do not handle well. Block 202 may be followed by block 204.

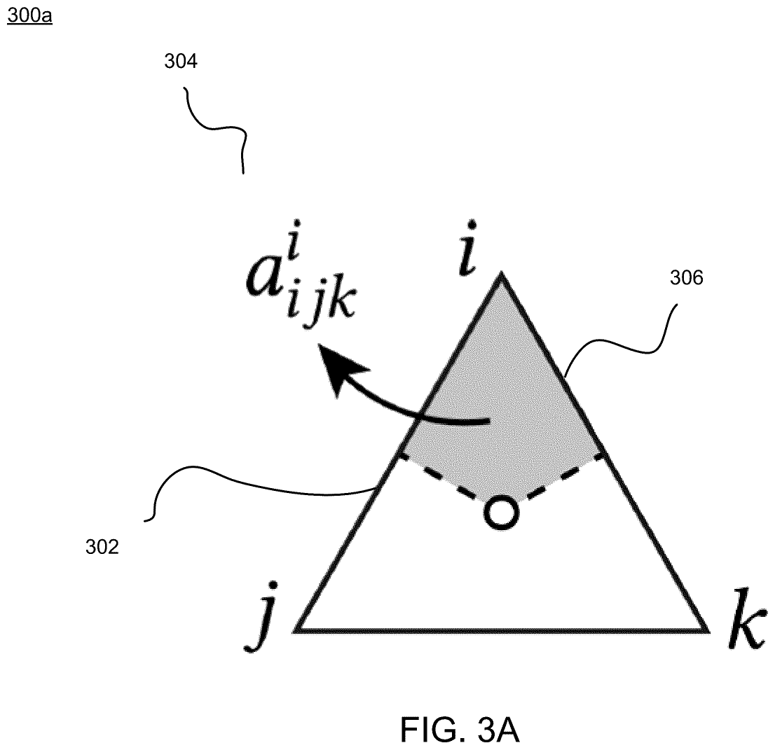

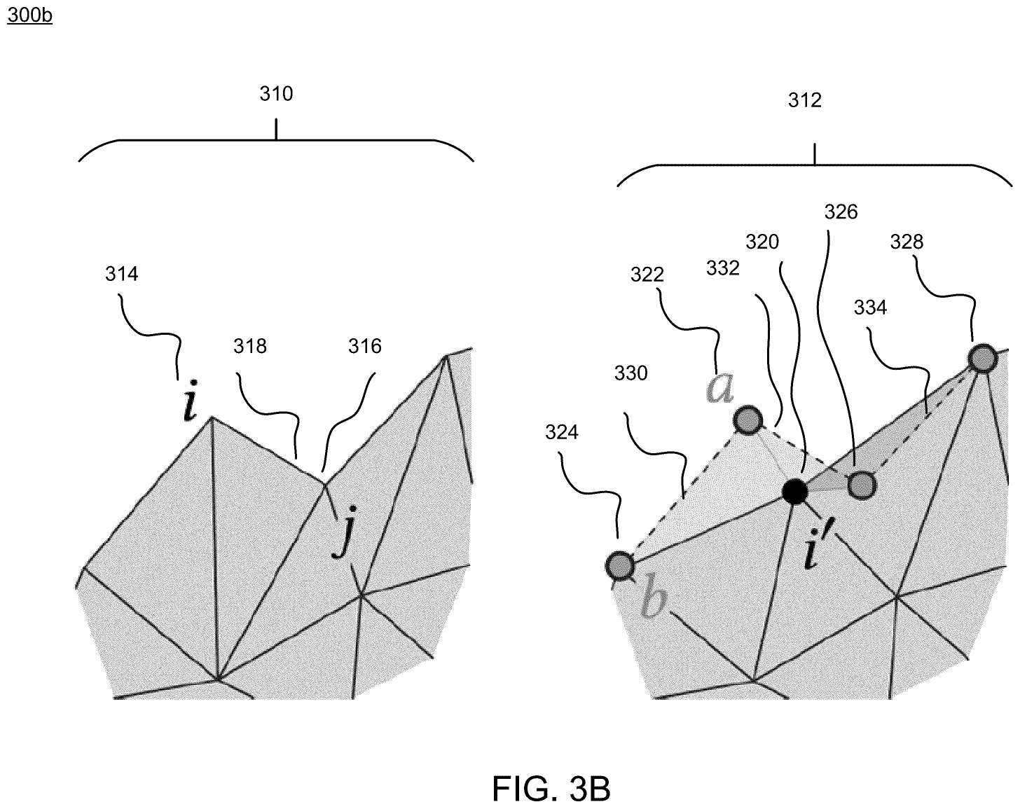

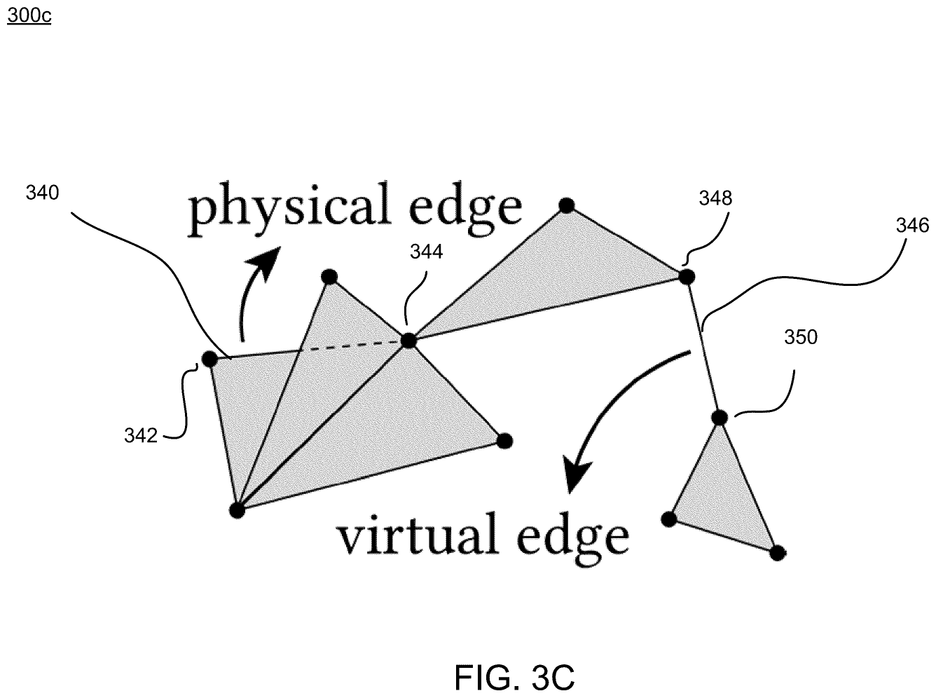

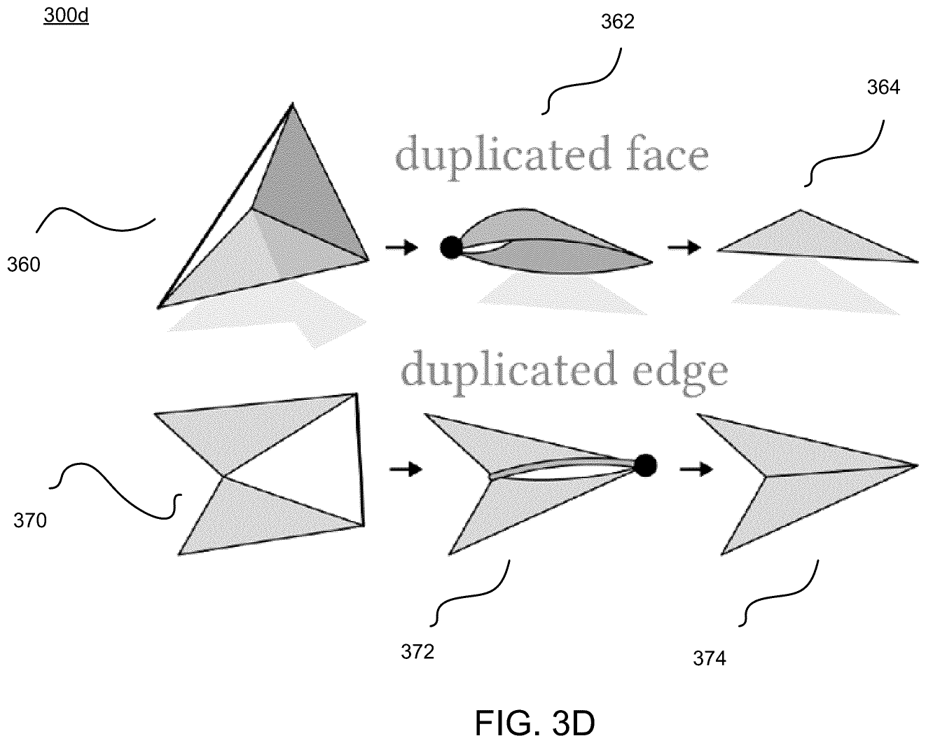

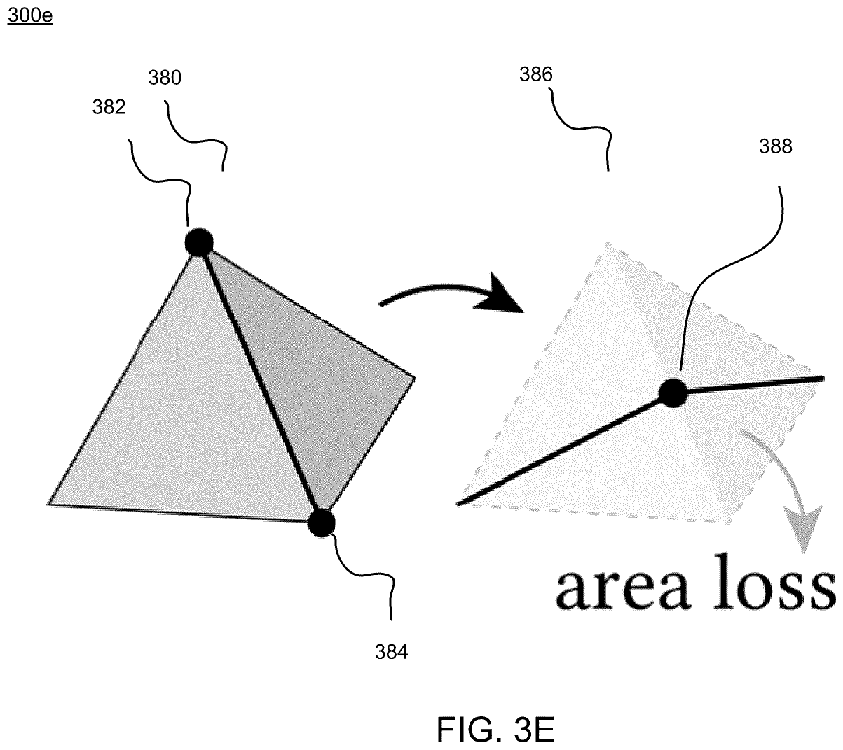

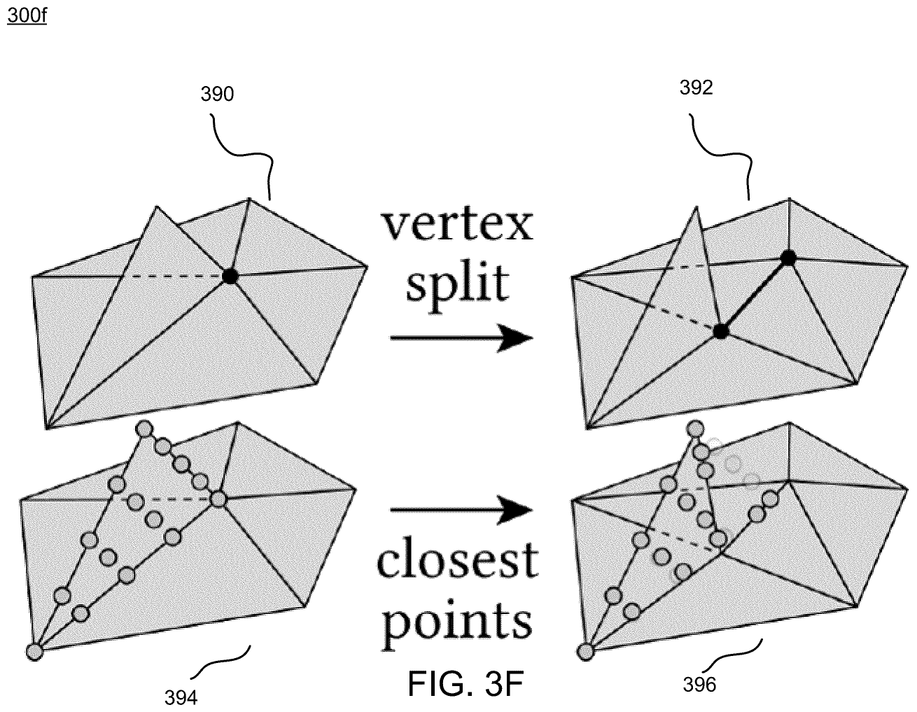

At block 204, an edge list for the initial triangle mesh is constructed. A preliminary step of the method 200a is to construct a set (or list) of (physical and virtual) edges E given a triangle mesh with vertices V and faces F. Then, each edge is greedily collapsed to simplify the model. Details of collapsing edges are presented in FIG. 2D. With respect to physical edges and virtual edges, physical edges denote that the corresponding vertex pair existed in F and virtual edges to denote that the corresponding pair does not exist in F. Examples of a physical edge and a virtual edge in a sample triangle mesh are presented in FIG. 3C.

Defining virtual edges is useful when decimating a scene with multiple components. Without using virtual edges, a simplification technique is limited to deleting only connected parts (i.e., parts specifically joined using a physical edge). Using virtual edges (in addition to physical edges) permits merging such virtual edges to possibly obtain a better approximation of a triangle mesh during decimation of triangles in the mesh. Details of constructing the edge list are presented in FIG. 2C. Block 204 may be followed by block 206.

At block 206, the initial triangle mesh is decimated. After constructing an edge list E (also referred to as an edge set) with physical and virtual edges, combining the edge list E with the initial vertex and triangle lists forms a simplicial complex (V, E, F). The fact that the initial input is a simplicial complex is relevant when choosing compatible data structures for implementing the techniques.

In some implementations, greedy edge collapses are used to simplify the connectivity of a simplicial complex (V, E, F). Collapsing an edge ij∈E is part of a process of unifying a vertex pair i, j to produce a new vertex i′ and updating the edges and the faces connecting to these vertices. A specific example of unifying a vertex pair is presented in FIG. 3B.

More precisely, all the edges in E and faces in F that are referring to vertex i, j are replaced by having all such edges and faces refer to new vertex i′. The replacement process may introduce degenerated edges and faces that connect the same new vertex i′ more than once. The replacement process may also introduce duplicated simplices that connect the same set of vertices. Thus, after updating E and F, some implementations may perform operations to remove the degenerated and/or duplicated simplices.

In some implementations, validity checks may be performed before collapse of the simplified triangle mesh to maintain the topology and mesh quality of the simplified triangle mesh (i.e., with respect to the initial triangle mesh). For example, validity checks may ascertain that a proposed collapse does not change the topology of the mesh, create non-manifold elements, and/or produce low quality triangles that are below a user-specified quality threshold.

Some implementations simplify triangle meshes that contain non-manifold elements. Such implementations prioritize modifying the topology (e.g., merging disjoint components), and may skip all or some of the validity checks. Some implementations may preserve the topology or the manifold structure. Such implementations can include validity checks and reject any edge(s) that violate the validity checks.

An aspect of mesh simplification is to define an error metric that prioritizes a sequence of edge collapses that occur in the mesh simplification. Using an edge quadric as an error metric leads to excellent results (results that maintain topology and mesh quality) in simplifying single manifold triangle meshes. When decimating meshes with multiple components, using an edge quadric without modification often provides lower quality outputs. Specifically, using an edge quadric without modification may lead to deleting components that are geometrically significant.

The issue of deleting geometrically significant components is especially pronounced if the component has a shape similar to that of a cone, a plane, or a developable surface (a smooth surface with zero Gaussian curvature). Meshes of such kinds are common in digital assets used for applications such as games, three-dimensional (3D) environments, and visual effects, such as trees or buildings.

A reason for deleting geometrically significant components occurring by using the edge quadric alone is that the edge quadric only considers a squared distance to triangle planes to calculate an error metric. If planes encoded in an edge quadric have a common intersection, the planes lead to a zero error as a part of contracting the edge, regardless of a way that contracting the edge affects the overall geometric error. While several quadric error variants are available, none of these quadric error variants alone is sufficient to solve the issue of simplifying triangle meshes in a way that removes geometrically significant components in real-life use cases.

A quadric error metric introduced herein is a combination of an edge quadric with memory and an area quadric without memory for boundary edges. Using the edge quadric with memory is motivated by the overall success of alternative approaches that use such an edge quadric. The usage of area quadric is to capture the area loss when deleting a mesh component. Combining the edge quadric with memory and the area quadric without memory may address issues that occur in each approach if used separately.

In some implementations, the area quadric is not accumulated throughout the decimation process. This approach of omitting accumulation of the area quadric is used because the techniques otherwise allow for contracting virtual edges. Contracting virtual edges may lead to assembling two boundary edges into a single interior edge. In such cases, accumulating area quadrics leads to having area quadrics defined on edges later on in the decimation.

Accumulating area quadrics when contracting virtual edges in this manner results in incorrectly high costs for removing the edges removed subsequently. Having such high area errors for interior edges is incorrect. Collapsing an interior edge often leads to some area gain on one side of an edge and some area loss on the other side of the edge.

To achieve correct results, the area gain and the area loss cancel out each other. In some situations, area quadrics do not differentiate between the two values (i.e., the area gain and the area loss). Area quadrics simply square the area gain and the area loss and sum up the results. Such an approach results in an unduly high cost when decimating long interior edges. The approach also leads to uniform decimation that does not preserve sharp features from an initial mesh.

To address the issues caused by using area quadrics without differentiation, some implementations simply use a memoryless version of the area quadric. The memoryless version of the area quadric computes the error on the fly for each edge decimation. The memoryless version of the area quadric also deletes the error after each collapse, while accumulating the edge quadric to provide the corresponding excellent performance of such an error metric.

In some implementations, comparable results to an approach using an area quadric may be achieved if the area quadric is replaced with a boundary quadric. This result holds because a sum of the boundary quadric and the triangle quadric equals the squared height of the triangle from the boundary edge. When this sum (i.e., the sum of the boundary quadric and the triangle quadric) is multiplied by the squared length of the boundary edge, this product results in the squared triangle area. The squared triangle area has a value corresponding to a same geometric quantity as the geometric quantity measured by the area quadric.

The relationship between values associated with the area quadric and the boundary quadric implies that replacing the area quadric with the boundary quadric is almost equivalent. There may possibly be a minor difference in the weighting between each of the terms, which may be neglected. Thus, in some implementations, the area quadric may be used because the area quadric is a more direct measure of the quantity (i.e., area change) the implementations are designed to capture. Block 206 may be followed by block 208.

At block 208, texture transfer is performed. Meshes in many use cases are associated with color textures. Such color textures may be used when rendering the meshes to color the outsides of the meshes. UV coordinates are commonly used to associate the mapping with a texture space that stores the surface attribute information.

An approach to preserve mesh textures during mesh simplification is to preserve their UV coordinates. Such an approach may work reasonably well for meshes with a few connected components in the UV domain (e.g., a manageable amount of error is introduced). For meshes with more connected components in the UV domain, these techniques often lead to texture distortion and bleeding.

Texture distortion and bleeding mean the background color gets interpolated to the surface, because the UV boundaries are not exactly preserved. This limitation led to techniques to maintain UV boundaries exactly. Using such techniques may lead to significant geometric distortion, and put a lower bound on the coarsest resolution.

Various implementations described herein thus take a different approach to manage texture distortion and bleeding. Some implementations compute a mapping from the simplified model (i.e., mesh) to the initial model (i.e., mesh). Such a mapping may include a combination of successive mappings and progressive simplicial complexes.

Using such a computed map, the implementations regenerate a new texture image after the simplification by copying the texture data from the original mesh with an entirely new UV mapping. Such an approach for successive mapping operations avoids texture bleeding. The approach for successive mapping operations also eliminates the resolution lower bound of UV-preserving simplification. Additional aspects of texture transfer are presented in the discussion of FIG. 2B. Block 208 may be followed by block 210.

At block 210, a three-dimensional (3D) virtual object is displayed by applying a texture image to the object (e.g., to the simplified triangle mesh). For example, the initial triangle mesh was decimated at block 206 to generate a simplified triangle mesh. The rendering of the 3D virtual object may be based on using available rendering techniques to render a triangle mesh. Instead of rendering based on the initial triangle mesh, the rendering is based on the simplified triangle mesh.

Because the simplified triangle mesh is used instead of the initial triangle mesh, the rendering of the 3D virtual object involves fewer computing resources, storage, and time. By simplifying the triangle mesh using techniques discussed herein, the simplified triangle mesh is easier to render. The simplified triangle mesh preserves topology and mesh quality from the initial triangle mesh to the extent possible while using fewer triangle. By using the texture image, the coloration of the surface of the 3D virtual object is also preserved in an effective manner, causing the exterior of original 3D virtual object to undergo minimal deterioration.

FIG. 2A presents a set of operations associated with block 202, block 204, block 206, block 208, and block 210 in a certain sequence. Some implementations may follow this sequence. Other implementations may modify this sequence, modify the way in which certain operations are performed, omit certain blocks, and/or add additional blocks to perform method 200a as illustrated in FIG. 2A.

FIG. 2B is a flowchart illustrating an example method 200b of determining color information for corresponding points using a correspondence map, in accordance with some implementations. Method 200b may begin at block 212.

At block 212, a point on the simplified triangle mesh associated with a point on the texture image is identified. Given an initial input mesh M⁰=(V, E, F) and its coarsened (i.e., simplified) counterpart M^{C}=(V_{C}, E_{C}, F_{C}), the implementations transfer texture colors from M⁰ to M^{C}. Without loss of generality, the implementations consider each pixel on the texture image as a colored point sample defined on the surface. Block 212 may be followed by block 214.

At block 214, a corresponding point on the initial triangle mesh is found using a correspondence map. Transferring textures amounts to computing a map T: M^{C}→M⁰ that transfers each point p∈M^{C} on the coarsened mesh to a corresponding point T(p)∈M on the initial input mesh. Then, the mesh is used to simply copy the color at T(p) and paste the color at the point p on M^{C}. With such information, the implementations can generate a new texture map using colors from {p} for visualization purposes.

Some implementations use a mesh color texture for storing the resulting texture data after simplification. Mesh color textures can be converted to corresponding mesh colors. Each sample of mesh colors corresponds to a specific location p on the corresponding surface. For computing the texture value at p, the implementations simply sample the original texture at the location that corresponds to T(p). Such a texture value yields the relevant corresponding color information.

Other texture mapping techniques can be used where each texel (where a texel is a texture element, that is a constituent element of a texture map) of the resulting texture image is either unused or corresponds to a precise position p on the corresponding surface. For example, a bijective (i.e., one-to-one) mapping that places all edges along seams vertically, horizontally, or diagonally along texel centers has this property.

In some implementations the mapping T from M^{C} to M is bijective (i.e., there is a one-to-one correspondence) with low distortion. Because the techniques presented herein permit topological changes (e.g., deleting a component), bijectivity may not apply. Furthermore, because there are no assumptions imposed on the input, the original mesh may include non-manifold vertices/edges. This aspect of the initial triangle mesh and other aspects of the initial triangle mesh may prevent techniques disclosed herein from using existing manifold parameterization techniques to minimize distortion.

Some implementations compute the map T by successive closest-point projection within the edge one-ring. Specifically, when decimating M⁰, implementations construct a progressive simplicial complex to manage going back and forth between the decimation sequence {M⁰, M¹, . . . , M^{C}}. Block 214 may be followed by block 216.

At block 216, color information is sampled. After decimation, implementations sample mesh color points of the coarsened mesh M^{C}, use a vertex split to obtain M^{C-}1, and then project the mesh color samples within the vertex one-ring of M^{C} to the edge one-ring of M^{C-1}. Implementations then continue the process of projecting within the vertex one-ring until the scope of the projection reaches M⁰. At the end of the successive projections, it is possible to obtain the correspondence between M^{C} to M⁰ via composition.

Some implementations measure the closest point of the points sampled on the coarsest mesh M^{C} to avoid accumulating errors due to map composition. This localized projection encourages (but does not guarantee) projection of each point on the simplified mesh to the part of the initial mesh the point comes from. Such localized projection is unlike the global closest point projection. Global closest point projection may project a point to the other side of a surface. In addition, performing projection locally at each edge of the one-ring also ensures a fast operation at each iteration.

FIG. 2B presents a set of operations associated with block 212, block 214, and block 216 in a certain sequence. Some implementations may follow this sequence. Other implementations may modify this sequence, modify the way in which certain operations are performed, omit certain blocks, and/or add additional blocks to perform method 200b as illustrated in FIG. 2B.

FIG. 2C is a flowchart illustrating an example method 200c of identifying virtual edges and using the virtual edges to simplify a triangle mesh, in accordance with some implementations. Method 200c may begin at block 222.

At block 222, triangle-to-triangle distances are measured. Implementations use the triangle-to-triangle distance to measure whether components are co-located. Such an approach is related to the construction of a Čech complex (an abstract simplicial complex constructed from a point cloud in any metric space that is meant to capture topological information about the point cloud or the distribution the point cloud is drawn from). The present approach replaces points as used with respect to a Čech complex with triangles. Specifically, implementations first compute the closest points between two triangles. These closest points can be located in the middle of an edge or a face for each triangle. Block 222 may be followed by block 224.

At block 224, it is determined that a distance between closest points (identified in block 222) is less than a threshold. In some implementations, it may be verified that the distance between the closest points identified in block 222 is below a small threshold, where the value of the threshold may be a hyperparameter set by a user to lead to various results. Block 224 may be followed by block 226.

At block 226, it is determined that closest points are not from the same connected component. This check ensures that, when the input is a single-component manifold mesh, the techniques can create the same high-quality results as off-the-shelf simplification algorithms. For example, it may be verified that the closest points identified in block 222 are not from a same connected component. Block 226 may be followed by block 228.

At block 228, a virtual edge is formed between a vertex pair. The vertex pair satisfies the conditions determined in block 224 (i.e., distance is less than a threshold) and block 226 (i.e., vertices are not from a same connected component). Adding a virtual edge includes adding an element to the edge list E that includes as its vertices two vertices from V that satisfy the properties to be endpoints of a virtual edge, even though a physical edge does not connect these vertices. Block 228 may be followed by block 230.

At block 230, a simplicial complex is formed. After constructing an edge list E with physical and virtual edges, combining the edge list E with the initial vertex lists and initial triangle lists forms a simplicial complex (V, E, F). Several data structures for manipulating simplicial complexes have been proposed to handle general simplices (e.g., high dimensional simplices) and to reduce a memory footprint of such simplices.

Implementations may perform edge collapses on triangle meshes (0-simplices to 2-simplices). Instead of using general purpose data structures implementations use a list of lists to represent the simplicial complex. For example, some implementations construct three lists to store the star information for each 0-simplex (vertex) and 1-simplex (edge).

In some implementations, three lists of lists may be used (stored). A first list of the lists represents a relationship of each vertex to corresponding one-ring edges. A second list of the lists represents the relationship of each vertex to corresponding one-ring faces. A third list of the lists represents the relationship of each edge to corresponding one-ring faces. For each edge collapse, implementations use the first, second, and third lists to gather neighboring simplices and update their connectivity correspondingly. Block 230 may be followed by block 232.

At block 232, edges are collapsed iteratively. Implementations use greedy edge collapses to simplify the connectivity of a simplicial complex (V, E, F). Details of such greedy edge collapses are presented in FIG. 2D.

FIG. 2C presents a set of operations associated with block 222, block 224, block 226, block 228, block 230, and block 232 in a certain sequence. Some implementations may follow this sequence. Other implementations may modify this sequence, modify the way in which certain operations are performed, omit certain blocks, and/or add additional blocks to perform method 200c as illustrated in FIG. 2C.

FIG. 2D is a flowchart illustrating an example method 200d of merging vertices, in accordance with some implementations. Method 200d may begin at block 240.

At block 240, a pair of vertices are merged. Implementations use greedy edge collapses to simplify the connectivity of a simplicial complex (V, E, F). Collapsing an edge ij∈E is a process of unifying a vertex pair i, j to a new vertex i′. Because the techniques use a greedy approach, each edge that is collapsed is chosen as the edge collapse that introduces the smallest amount of geometric error. Block 240 may be followed by block 242.

At block 242, edges and faces are updated. This updating includes updating the edges and the faces connecting to them. More precisely, all the edges in E and faces in F that refer to vertex i, j are replaced by references to vertex i′. This process may introduce degenerate edges and/or faces that connect the same vertex i′ more than once. The process may also introduce duplicate simplices that connect a same set of vertices. Thus, after updating E and F, some implementations process the simplices to remove the degenerate and duplicate simplices. Aspects of such an updating are presented in detail in FIG. 3B.

FIG. 2D presents a series of operations associated with block 240 and block 242 in a certain sequence. Some implementations may follow this sequence. Other implementations may modify this sequence, modify the way in which certain operations are performed, omit certain blocks, and/or add additional blocks to perform method 200d as illustrated in FIG. 2D.

FIG. 3A is a diagram illustrating using vertex quadrics 300a, in accordance with some implementations. FIG. 3A illustrates using a barycentric area for a triangle. For example, there may be a triangle 302 with vertices i, j, and k. FIG. 3A illustrates that aᵢⱼₖⁱ 304 has size of aᵢⱼₖ/3, which is one third of face area aᵢⱼₖ 306. As discussed herein, aᵢⱼₖⁱ 304 is a portion of the vertex area at i coming from face ijk. As discussed, this provides a barycentric area, and this derivation can be used in the vertex quadric to provide weights in the weighted summation of one-ring triangle quadrics.

FIG. 3B is a diagram illustrating using area quadrics 300b, in accordance with some implementations. This area quadric

$${Q}_{ij}^{A}$$

is derived from summing up the squared area (computed with cross products) from each boundary edge ab to the newly insertex vertex i′. This result implies that this area quadric is merely an approximation to the actual area change. The measure ignores the cancelation between the area gain and the loss. The proxy maintains the favorable quadratic expression and can be seamlessly incorporated into the quadric-based mesh simplification.

Prior to an edge collapse, there are vertices i 314 and j 316, as illustrated in diagram 310. Vertices i 314 and j 316 are connected by an edge ij 318.

After the edge collapse, there are ab one-ring edges, as illustrated in diagram 312. For example, vertices i 314 and j 316 are replaced by an updated vertex i′ 320. Vertex i′ 320 may be associated with boundary vertex 322, boundary vertex 324, boundary vertex 326, and boundary vertex 328. These vertices are associated with boundary edge 330, boundary edge 332, and boundary edge 334.

The area quadric

$${Q}_{ij}^{A}$$

is derived from summing up the squared area (computed with cross products) from each boundary edge ab (e.g., boundary edge 330, boundary edge 332, and boundary edge 334) to the newly inserted vertex i′. This result implies that this area quadric is merely an approximation to the actual area change. The measure ignores the cancelation between the area gain and the loss. The proxy maintains the favorable quadratic expression and can be seamlessly incorporated into the quadric-based mesh simplification.

FIG. 3C is a diagram illustrating a physical edge and a virtual edge 300c, in accordance with some implementations. For example, FIG. 3C illustrates a physical edge 340 and a virtual edge 346. Physical edges denote vertex pairs that exist in F. Virtual edges denote vertex pairs that do not exist in F. In the example of FIG. 3C, physical edge 340 connects vertex 342 and vertex 344. While a portion of physical edge 340 is a solid line and a portion of physical edge 340 is a dashed line (indicating a three-dimensional (3D) depth effect), physical edge 340 is illustrated as an edge directly connecting vertex 342 and vertex 344 in FIG. 3C.

By contrast, virtual edge 346 connects two vertices that are from triangles without direct contact with one another. Specifically, virtual edge 346 connects vertex 348 and vertex 350. FIG. 3C illustrates that vertex 348 and vertex 350 are from unconnected triangles. A virtual edge 346 is constructed to join vertex 348 and vertex 350.

Such virtual edges indicate that two vertices have a relationship to one another that is to be considered when decimating edges for a triangle mesh, even if the vertices are not part of a same triangle. As discussed herein, a virtual edge may be formed for triangle vertices for a vertex pair that is closest to an actual closest point pair for two triangles, where the vertices are sufficiently close (i.e., less than a threshold distance) and are not from the same connected component.

FIG. 3D is a diagram illustrating vertex pair collapses 300d, in accordance with some implementations. FIG. 3D illustrates an initial mesh 360. After initial mesh 360 is simplified, the result is a simplified mesh having a duplicated face 362. After deduplication, simplified mesh having a duplicated face 362 becomes deduplicated simplified mesh 364.

FIG. 3D also illustrates an initial mesh 370. After initial mesh 370 is simplified, the result is a simplified mesh having a duplicated edge 372. After deduplication, simplified mesh having a duplicated edge 372 becomes deduplicated simplified mesh 374.

FIG. 3E is a diagram illustrating area loss 300e, in accordance with some implementations. FIG. 3E illustrates an initial mesh component 380 and simplified mesh 386. The usage of area quadric is to capture the area loss when deleting a mesh component. FIG. 3E illustrates visually some of the concepts presented in the discussion of block 206 in the discussion of FIG. 2A.

For example, initial mesh component 380 may include vertex 382 and vertex 384, which may be collapsed in simplified mesh 386 into vertex 388. Accordingly, simplified mesh 386 may be associated with an area loss. The area loss is captured using an area quadric, which represents ways of deleting a mesh component affect an area associated with the mesh.

FIG. 3F is a diagram illustrating a vertex split and closest points 300f, in accordance with some implementations. FIG. 3F illustrates an initial mesh 390. Initial mesh 390 is affected by a vertex split operation, producing simplified mesh 392. Mesh 394 illustrates a plurality of initial points associated with initial mesh 390. Mesh 394 is affected by a closest points operation, resulting in simplified mesh associated with closest points 396.

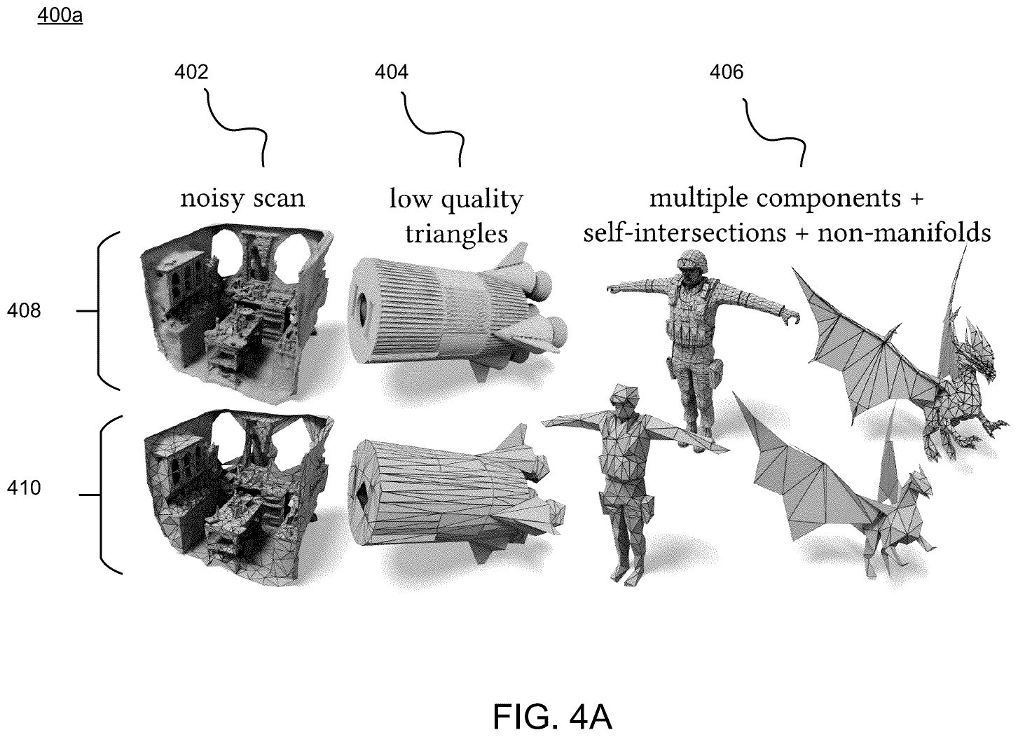

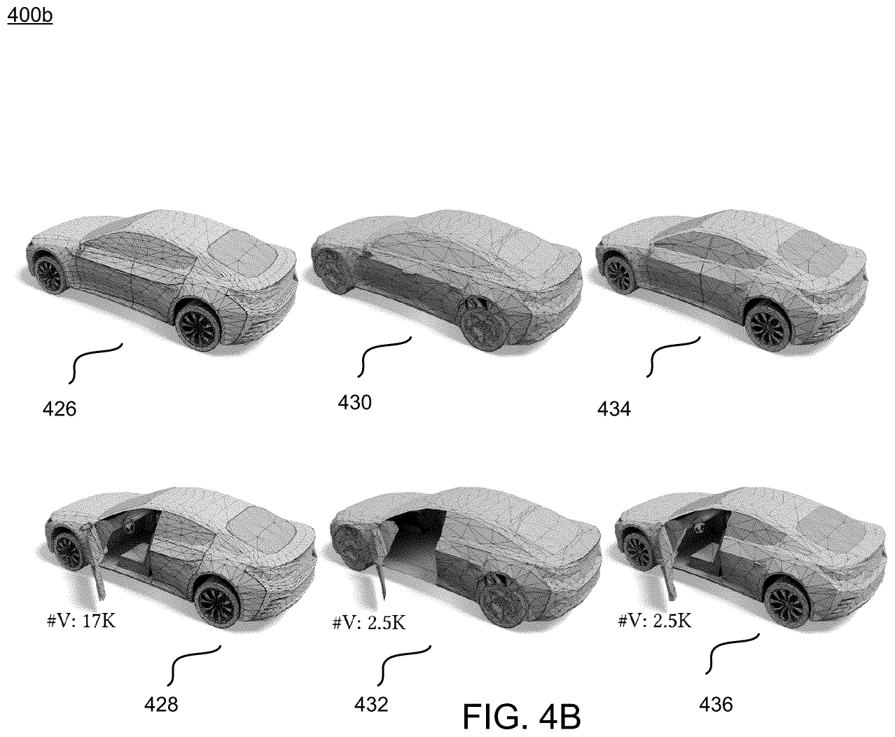

FIG. 4A is a diagram illustrating using techniques in various difficult use cases 400a, in accordance with some implementations. Such difficult use cases may occur when simplifying meshes in certain actual use cases. Alternative techniques for mesh simplification may provide poor results in these use cases.

For example, there may be a use case including a noisy scan 402. Such a noisy scan 402 may refer to a scan of a three-dimensional (3D) model that includes noise that interferes with a quality of the resulting mesh. There may be another use case including low quality triangles 404. For example, such low quality triangles may define an initial mesh in a use case where the initial mesh is obtained from a computer-aided design (CAD) model.

There may also be a use case including defects or aspects that are difficult to model. Examples of such aspects may include multiple components, self-intersections, non-manifolds, and/or combinations of such difficult aspects 406. FIG. 4A also presents a row of original meshes 408 and a row of simplified meshes 410 provided using techniques described herein.

FIG. 4A illustrates that, in a variety of actual scenarios, the techniques described herein provided good results (i.e., the topology and mesh quality are preserved while reducing a triangle count). For example, each original mesh in the original meshes 408 has a counterpart in the simplified meshes 410. The simplified meshes 410 decrease a triangle count while preserving most of the quality of the corresponding original meshes 408.

FIG. 4B is a diagram illustrating techniques that simplify an initial mesh while preserving interior structures of a 3D object 400b, in accordance with some implementations. FIG. 4B includes sets of initial meshes, simplified meshes provided by an alternative technique, and simplified meshes provided by techniques described herein.

With respect to the sets of initial meshes, FIG. 4B illustrates an initial mesh 426 of an automobile with a closed door and an initial mesh 428 of an automobile with an open door as input. The initial meshes (initial mesh 426 of an automobile with a closed door and initial mesh 428 of an automobile with an open door) each have about 17,000 vertices.

The present disclosure refers to certain numbers of vertices, which serve as a proxy for the number of triangles in an initial mesh or a number of triangles in a simplified mesh. The present disclosure refers to “about” a quantity of vertices to denote that such a mesh may include that number of vertices or a similar number of vertices (i.e., a number of vertices within a small threshold of the recited number of vertices).

In an alternative technology for mesh simplification, the mesh may be simplified down to about 2,500 vertices using simplified meshes provided by an alternative technique. This alternative technique may have difficulties with interior structure. For example, the wheel rims and the interior of the automobile cabin may lack definition, as illustrated in simplified mesh 430 of an automobile with a closed door and simplified mesh 432 of an automobile with a closed door. Simplified mesh 430 and simplified mesh 432 illustrate that the meshes provided by an alternative technique may lead to quality issues.

Using the techniques presented herein to provide simplified meshes produced by techniques as described herein, it is possible to preserve the wheel rims and the interior aspects of the automobile (e.g., steering wheel, driver's seat) with greater fidelity. With respect to the simplified meshes produced by techniques as described herein, FIG. 4B illustrates simplified mesh 434 and simplified mesh 436.

Simplified mesh 434 and simplified mesh 436 are also simplified down to about 2,500 vertices. Simplified mesh 434 better preserves wheel rim structure than simplified mesh 430. Simplified mesh 436 also better preserves wheel rim structure than simplified mesh 432. Simplified mesh 436 also better preserves internal automobile structure than simplified mesh 432. The door is better preserved, and further a car seat and a steering wheel are preserved effectively.

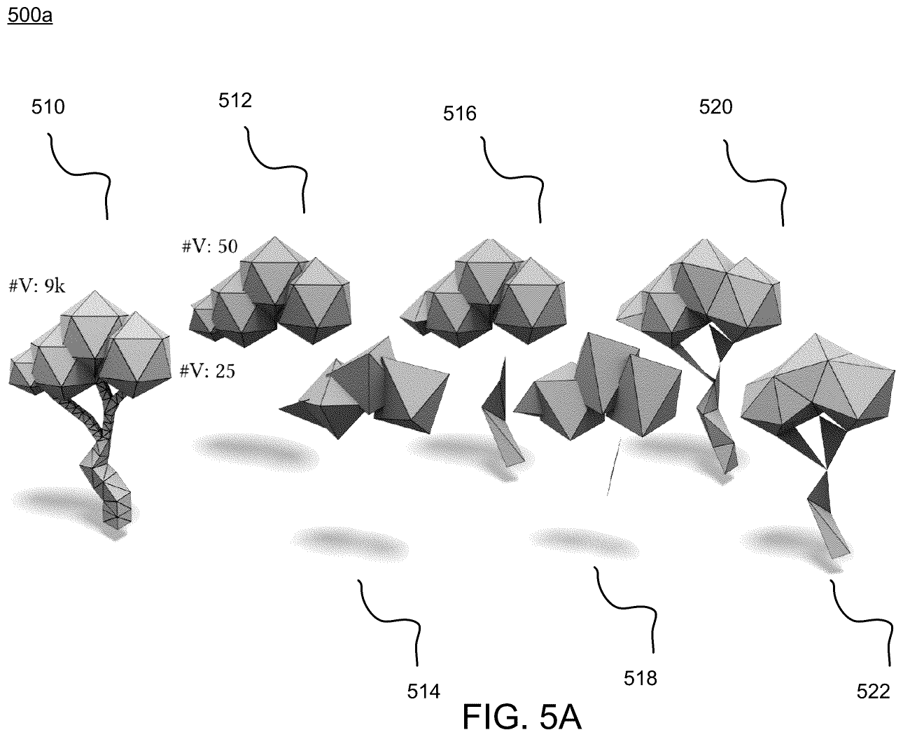

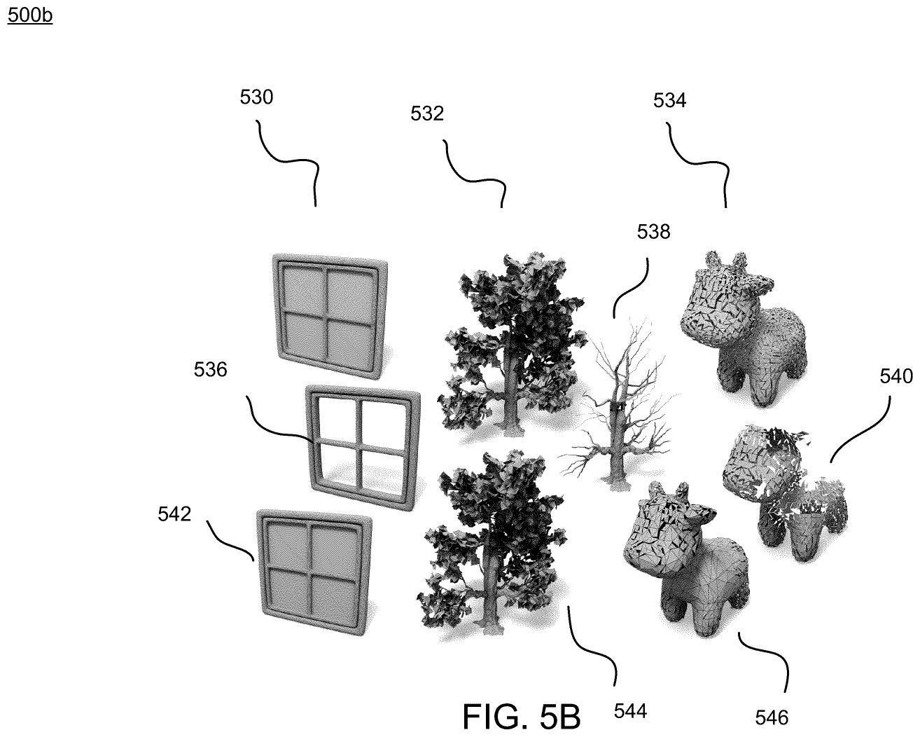

FIG. 5A is a diagram illustrating using virtual edges based on triangle distances 500a, in accordance with some implementations. FIG. 5A illustrates an initial mesh 510 with about 9,000 vertices. An aspect of initial mesh 510 as illustrated in FIG. 5A is that initial mesh 510 includes an upper structure that is originally modeled effectively using a few vertices and/or triangles (i.e., tops of a bush) and lower structure that is originally modeled using a large quantity of triangles.

There may be alternative techniques that result in poor quality meshes when significantly simplifying initial mesh 510. For example, there may be simplified versions of initial mesh 510 that reduce the vertex count to about 50 vertices or about 25 vertices. There may be a simplified mesh 512 where the mesh includes about 50 vertices or a simplified mesh 514 where the mesh includes about 25 vertices. Simplified mesh 512 and simplified mesh 514 are based on an alternative technique that is solely based physical edges. Simplified mesh 512 and simplified mesh 514 perform poorly at capturing a lower portion of initial mesh 510.

As another example, there may be simplified versions of initial mesh 510 that reduce the vertex count to about 50 vertices or about 25 vertices. There may be a simplified mesh 516 where the mesh includes about 50 vertices or a simplified mesh 518 where the mesh includes about 25 vertices.

Simplified mesh 516 and simplified mesh 518 are based on an alternative technique that uses vertex distances to generate virtual edges. Simplified mesh 516 and simplified mesh 518 perform somewhat better at capturing a lower portion of initial mesh 510 than the alternative of using only physical edges but still include defects in the representation of the lower portion of initial mesh 510.

Using techniques presented herein, there may be simplified versions of initial mesh 510 that reduce the vertex count to about 50 vertices or about 25 vertices. There may be a simplified mesh 520 where the mesh includes about 50 vertices or a simplified mesh 522 where the mesh includes about 25 vertices.

Simplified mesh 520 and simplified mesh 522 are constructed using techniques presented herein that uses triangle distances to generate virtual edges. Simplified mesh 520 and simplified mesh 522 perform considerably better at capturing a lower portion of initial mesh 510 than the alternatives using only physical edges or virtual edges obtained from vertex distances.

Simplified mesh 520 and simplified mesh 522 still provide a simplified representation of the lower portion of initial mesh 510 as compared to the original representation (i.e., a few triangles represent a structure that previously included thousands of triangles). Simplified mesh 520 and simplified mesh 522 provide a representation of the lower portion of initial mesh 510 that is of high quality given the constraints on an available number of triangles.

FIG. 5B is a diagram illustrating techniques to avoid deleting geometrically significant parts of an initial mesh by penalizing collapses that introduce significant area change 500b, in accordance with some implementations. Simplifying the initial mesh with the edge quadric error may lead to deleting geometrically significant parts because they lead to nearly zero quadric error. Various implementations overcome such issues by penalizing collapses that introduce significant area change.

FIG. 5B illustrates three sets of initial meshes. These sets of initial meshes include an initial mesh 530 of a window, an initial mesh 532 of a bush, and an initial mesh 534 of a baby cow. According to an alternative technique, a simplified mesh 536 also represents a window. Simplified mesh 536 looks different from initial mesh 530 in that simplified mesh 536 introduces transparency that was not previously present in the initial mesh 530. A simplified mesh 542 provided in accordance with techniques presented herein preserves the appearance of initial mesh 530 while still simplifying the initial mesh 530.

According to an alternative technique, a simplified mesh 538 also represents a bush. Simplified mesh 538 looks different from initial mesh 532 in that simplified mesh 538 does not properly include leaves that were previously present in the initial mesh 530. A simplified mesh 544 provided in accordance with techniques presented herein preserves the appearance of initial mesh 532 while still simplifying the initial mesh 532.

According to an alternative technique, a simplified mesh 540 also represents a baby cow. Simplified mesh 540 looks different from initial mesh 534 in that simplified mesh 540 introduces defects that were not previously present in the initial mesh 534. A simplified mesh 546 produced in accordance with techniques presented herein preserves the appearance of initial mesh 534 while still simplifying the initial mesh 534.

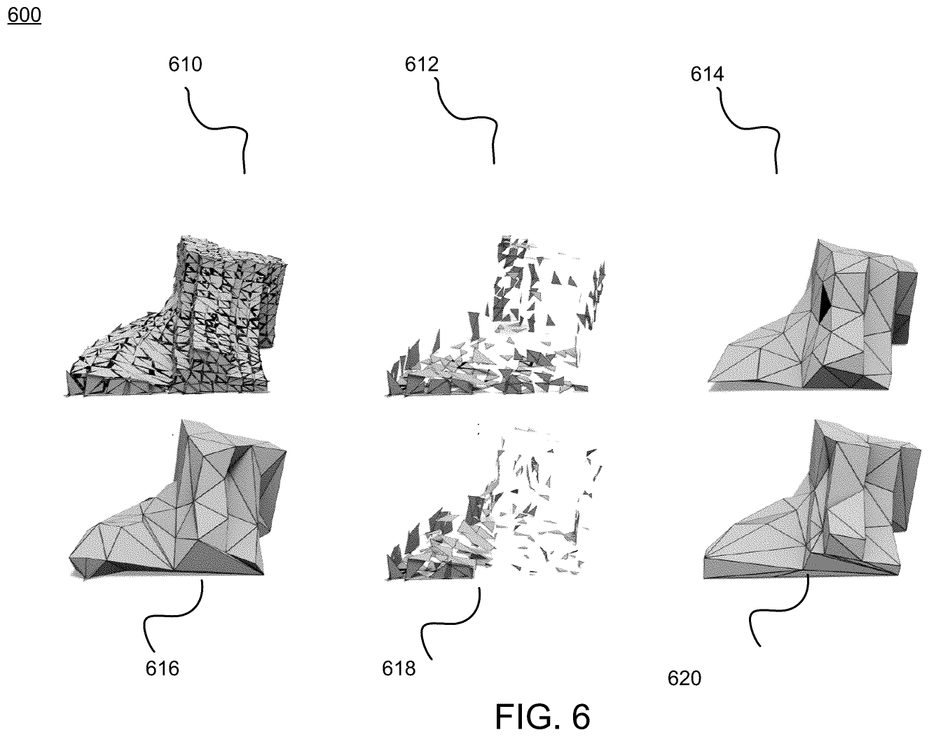

FIG. 6 is a diagram illustrating techniques to simplify a triangle mesh that use a modified quadric error metric to preserve sharp geometric features 600, in accordance with some implementations. For example, FIG. 6 illustrates various approaches used to simplify a triangle soup with a variety of alternative quadrics augmented with the virtual edges obtained from triangle distances-triangle-to-triangle (T2T)—as mentioned herein.

Other approaches tend to delete triangles because the approaches do not incorporate area losses. Such approaches lead to uniform decimation results and fail to preserve features. The modified quadric error metric provided in various implementations leads to a better result in preserving the sharp geometric features of an initial mesh in a simplified mesh.

For example, FIG. 6 illustrates an initial mesh 610 including a triangle soup as input. There are four alternative techniques illustrated in FIG. 6 that illustrate processing initial mesh 610 using T2T techniques. FIG. 6 illustrates simplified mesh 612 provided using a first alternative technique, simplified mesh 614 provided using a second alternative technique, simplified mesh 616 provided using a third alternative technique, simplified mesh 618 provided using a fourth alternative technique, and simplified mesh 620 provided using techniques described in the present disclosure.

Simplified mesh 612 and simplified mesh 618 illustrate that using such simplification techniques results in using many small triangles and produce gaps in the resulting simplified mesh. Simplified mesh 614 and simplified mesh 616 do a somewhat better job of simplifying the overall mesh but still result in localized areas that are not simplified well. Simplified mesh 620, which uses techniques presented herein, does a good job of producing a simplified mesh 620 that reproduces the initial mesh 610 by capturing an object originally defined by a triangle soup well while avoiding localized gaps or defects and successfully minimizing a triangle count.

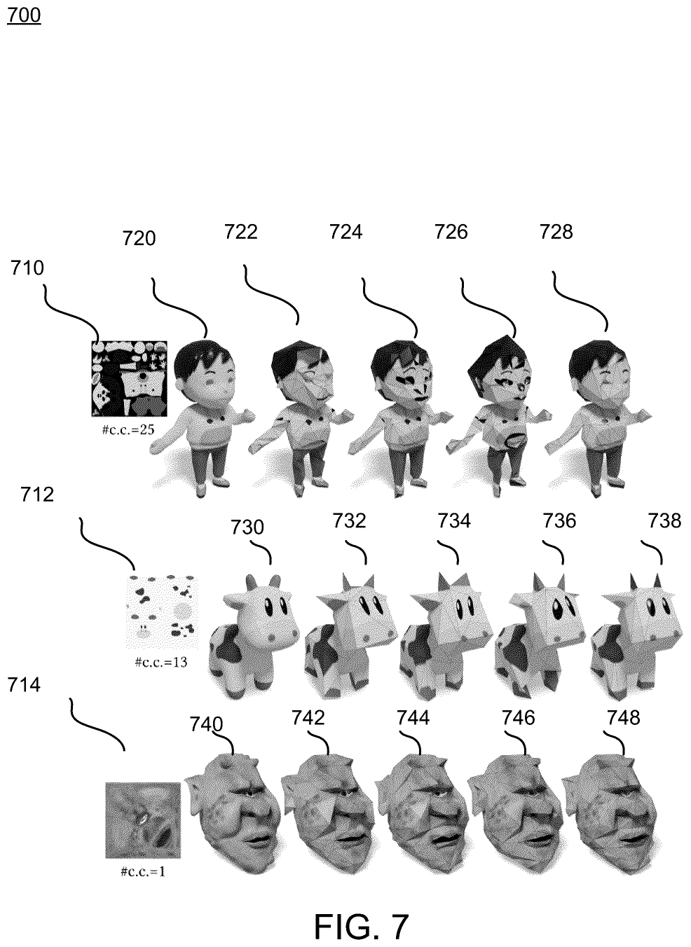

FIG. 7 is a diagram illustrating techniques to simplify a triangle mesh that avoid texture bleeding 700, in accordance with some implementations. Alternative techniques simplify a mesh while preserving the UV-coordinates of the mesh for transferring texture information to the simplified mesh.

The alternative techniques may lead to texture bleeding. The techniques presented herein avoid texture bleeding by computing correspondences between the input and the simplified counterpart of the input. Such an approach ensures that implementations transfer textures defined on the input surface, preventing texture bleeding.

FIG. 7 illustrates a first texture 710, a second texture 712, and a third texture 714. For example, first texture 710 corresponds to initial mesh 720 of a child. Second texture 712 corresponds to initial mesh 730 of a baby cow. Third texture 714 corresponds to initial mesh 740 of a cyclops head.

Simplified mesh 722, simplified mesh 724, and simplified mesh 726 illustrate various ways of projecting first texture 710 onto simplified versions of initial mesh 720, but these approaches illustrate that these techniques lead to texture bleeding. Simplified mesh 728, constructed using the techniques presented herein, projects first texture 710 onto a simplified mesh 728 of a child while effectively controlling texture bleeding.

Simplified mesh 732, simplified mesh 734, and simplified mesh 736 illustrate various ways of projecting second texture 712 onto simplified versions of initial mesh 730, but these approaches illustrate that these techniques lead to texture bleeding. Simplified mesh 738, constructed using the techniques presented herein, projects second texture 712 onto a simplified mesh 738 of a baby cow while effectively controlling texture bleeding.

Simplified mesh 742, simplified mesh 744, and simplified mesh 746 illustrate various ways of projecting third texture 714 onto simplified versions of initial mesh 740, but these approaches illustrate that these techniques lead to texture bleeding. Simplified mesh 748, constructed using the techniques presented herein, projects third texture 714 onto a simplified mesh 748 of a cyclops head while effectively controlling texture bleeding. In FIG. 7, “C.C.” stands for “connected components.”

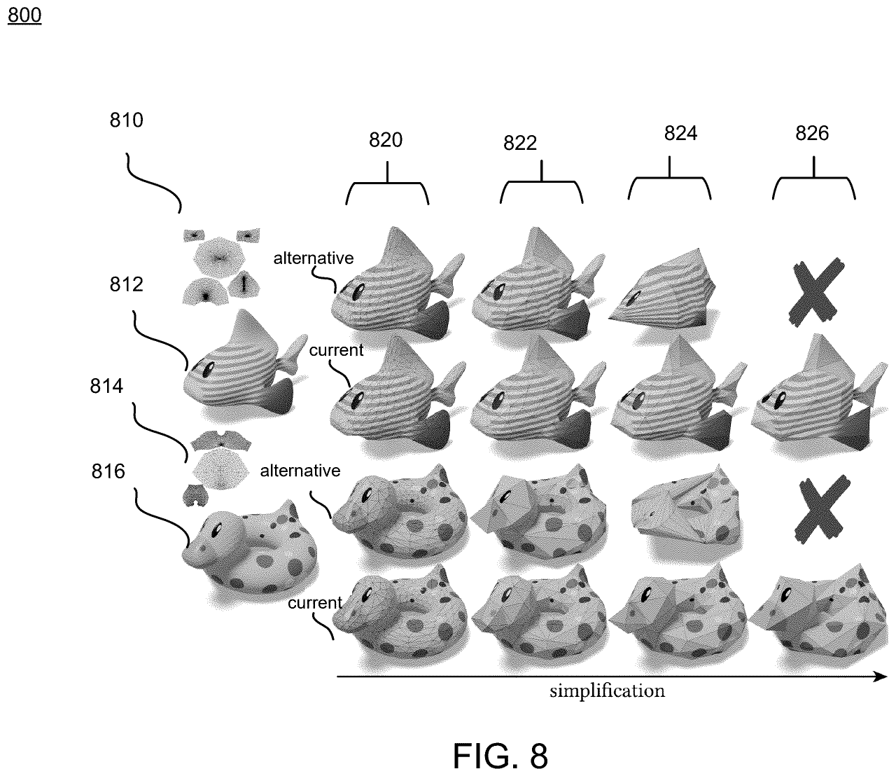

FIG. 8 is an additional diagram illustrating techniques to simplify a triangle mesh that avoid texture bleeding 800, in accordance with some implementations. An alternative technique to avoid texture bleeding is to preserve the UV boundaries exactly. This alternative technique often leads to stronger geometric distortion and leads to a lower bound on the resolution of the simplified mesh. The techniques presented herein can decimate the mesh aggressively while still being able to transfer texture colors without degradation of the output.

For example, there may be a texture 810 to project onto a mesh of a fish 812. There may be a succession of simplifications first simplification 820, second simplification 822, third simplification 824, and final simplification 826. In the alternative approach, first simplification 820, second simplification 822, and third simplification 824 cause sufficient geometric distortion that final simplification 826 is unusable. In the present implementations, first simplification 820, second simplification 822, and third simplification 824 manage geometric distortion in a way that final simplification 826 is still usable.

As another example, there may be a texture 814 to project onto a mesh of a duck 816. There may be a succession of simplifications first simplification 820, second simplification 822, third simplification 824, and final simplification 826. In the alternative approach, first simplification 820, second simplification 822, and third simplification 824 cause sufficient geometric distortion that final simplification 826 is unusable. In the present implementations, first simplification 820, second simplification 822, and third simplification 824 manage geometric distortion in a way that final simplification 826 is still usable.

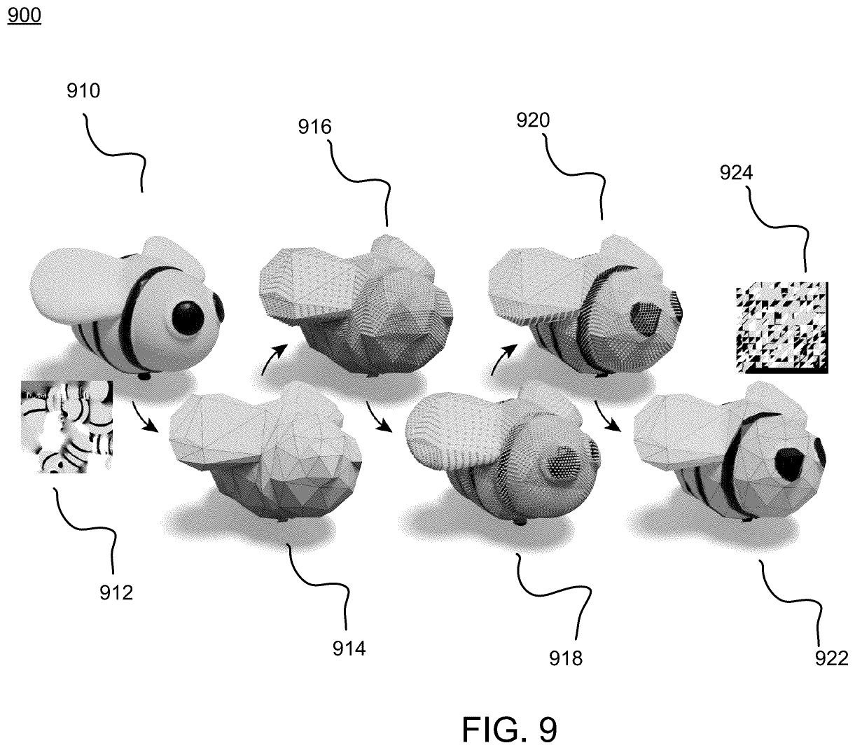

FIG. 9 is a diagram illustrating successive stages of simplifying a triangle mesh 900, in accordance with some implementations. Given an initial mesh 910 associated with an initial texture 912, implementations simplify the initial mesh 910 into a simplified mesh 914 while computing a successive map 916 from the simplified mesh 914 to the initial mesh 910.

With such information, implementations can sample points on the successive map 916, correspondences to the pixel location in the texture image, and transfer those points to the input with the correspondence map 918. Then implementations can simply look up the color information 920 and generate a new texture image after simplification 922 associated with relevant corresponding colors in texture 924.

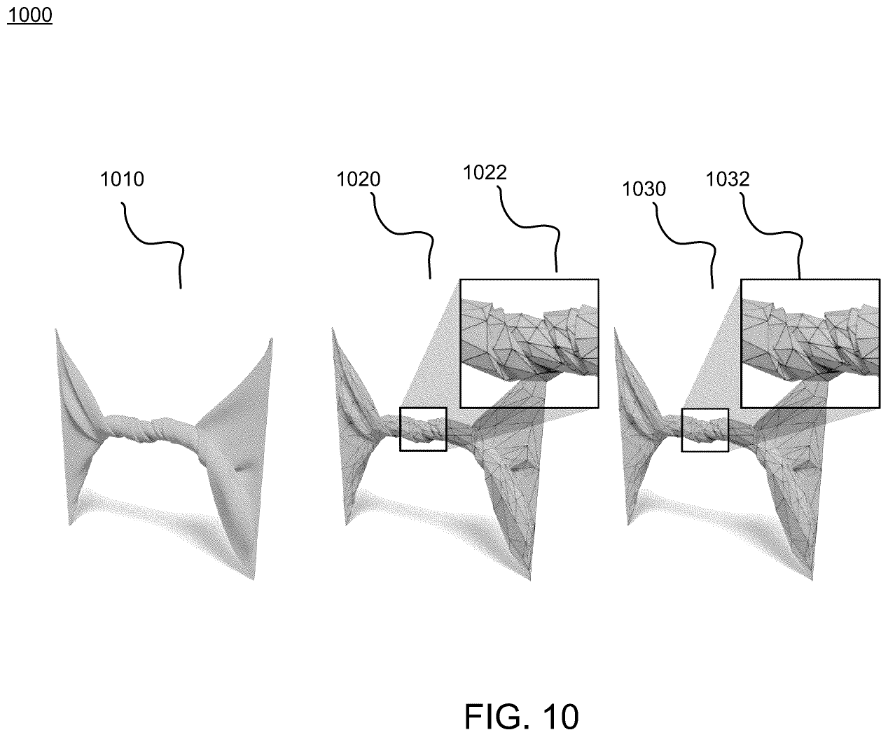

FIG. 10 is a diagram illustrating techniques to improve projections 1000, in accordance with some implementations. In some implementations, the mesh to simplify is a thin shell cloth mesh with different shading on different sides 1010. Naïve closest point projection between the simplified and the initial meshes may lead to projecting points onto the wrong side by producing simplified mesh 1020. An expanded view of such incorrect projection is illustrated at expanded view 1022 of simplified mesh 1020.

Successive closest point projection according to techniques disclosed herein encourages the projection to lie on the side of simplified mesh 1030, leading to less projection error. An expanded view of such improved projection is illustrated at expanded view 1032 of simplified mesh 1030.

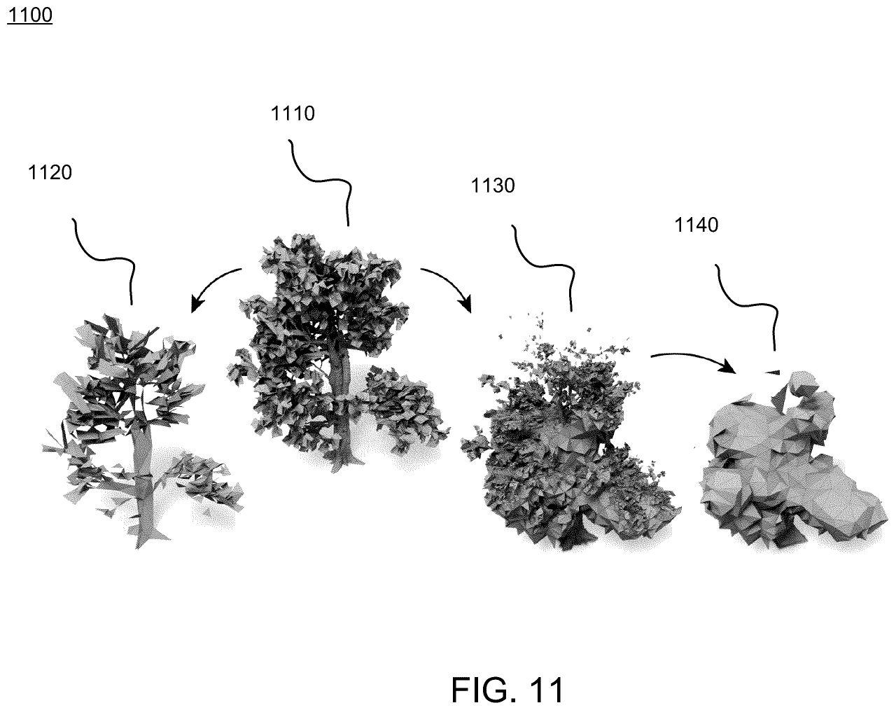

FIG. 11 is a diagram illustrating techniques to repair a triangle mesh 1100, in accordance with some implementations. FIG. 11 illustrates an initial mesh 1110 depicting a bush. One approach includes repairing an initial mesh 1110 into a repaired mesh 1130 based on initial mesh 1110 and then simplifying the repaired mesh 1130 to result in a simplified model 1140.

Such simplification depends on having access to a high quality repaired mesh 1130. Access to a high quality repaired mesh 1130 is not guaranteed, and sometimes no such mesh is available. Various implementations simplify the initial mesh 1110 directly. Such an approach leads to a resulting simplified 1120 that better preserves the structure of the initial mesh 1110 by using techniques presented herein.

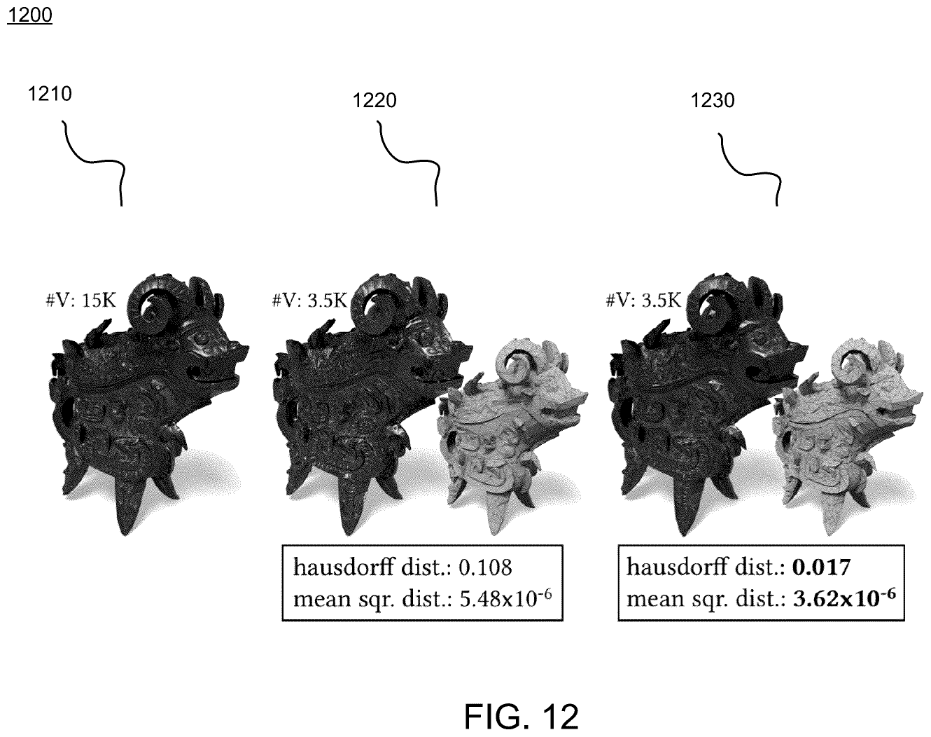

FIG. 12 is a diagram illustrating comparing techniques to alternative techniques 1200, in accordance with some implementations. Compared to an alternative expensive mesh optimization technique with differentiable rending that usually takes a few hours, the implementations are orders of magnitude faster and achieve comparable quality. For example, FIG. 12 illustrates an initial mesh 1210 depicting a ram. The initial mesh 1210 depicting the ram includes about 15,000 vertices.

Using a simplified mesh 1220 depicting the ram produced using other techniques may simplify the initial mesh 1210 of the ram to about 3,500 vertices. The techniques described herein produce another simplified mesh 1230 of the ram that has about 3,500 vertices. The simplified mesh 1220 of the ram and the simplified mesh 1230 of the ram are of similar quality (the Hausdorff distance and the mean square distance are both good) but the present techniques are orders of magnitude faster and achieve comparable quality.

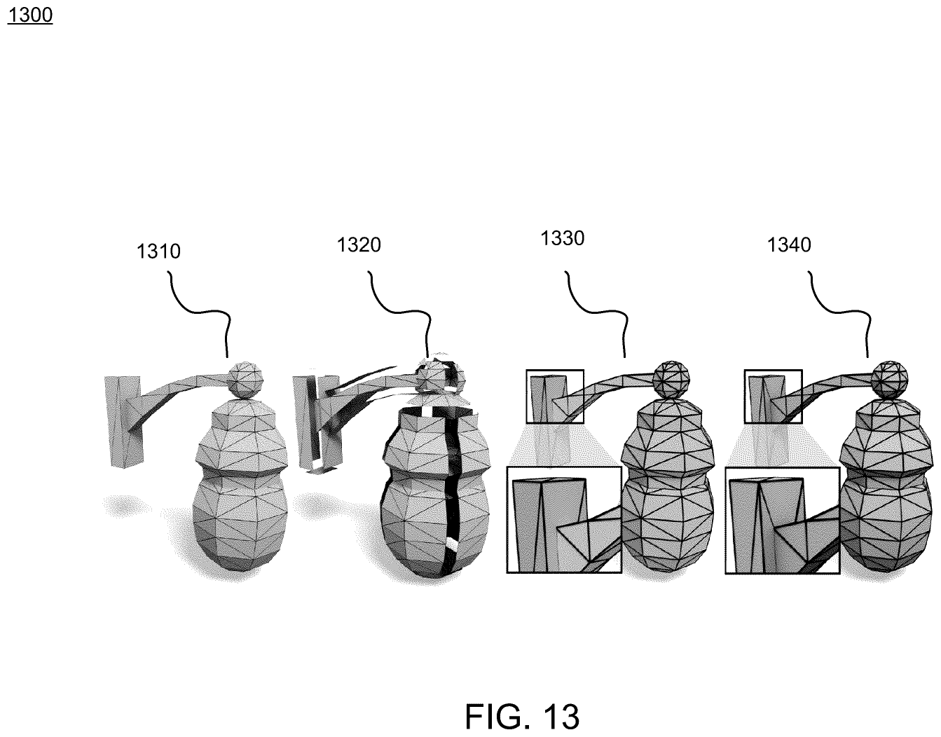

FIG. 13 is a diagram illustrating techniques to manage a single connected rigid object, with a complicated shape 1300, in accordance with some implementations. FIG. 13 illustrates an initial mesh 1310 of a street lamp mesh representing a single connected rigid object. The raw data 1320, though, may contain several disconnected components from the modeling process. Using a vertex distance approach to infer the connectivity in simplified mesh 1330 still leads to 4 disconnected components indicated by different colors. Using triangle distance techniques presented herein leads to a simplified mesh 1340 that defines a single component with high quality. Both physical and virtual edges are illustrated with thick black lines in simplified mesh 1330 and simplified mesh 1340.

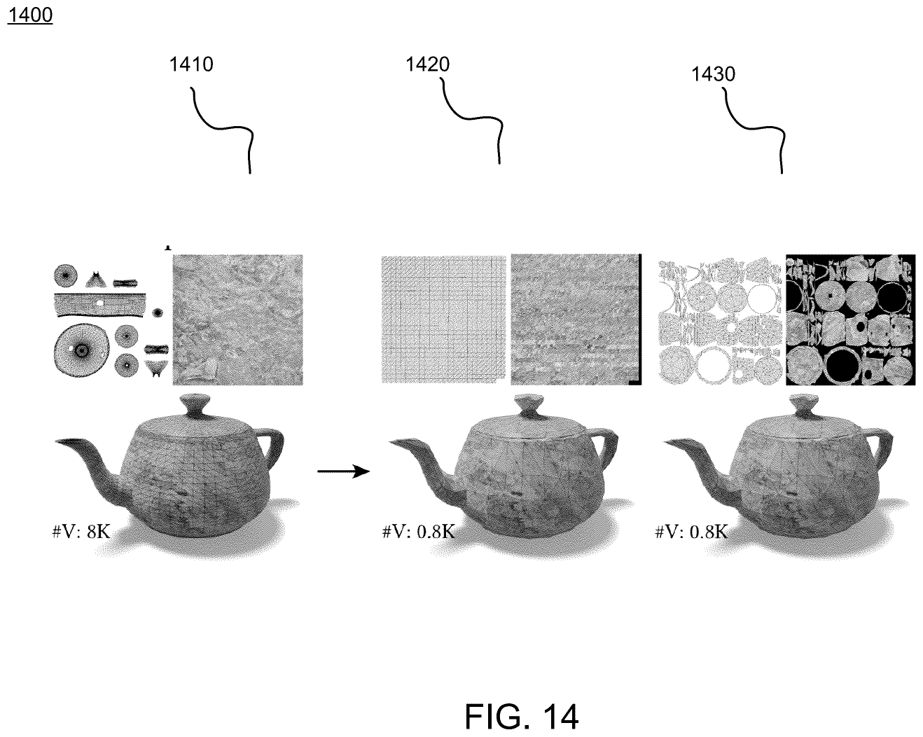

FIG. 14 is a diagram illustrating techniques to regenerate UV-coordinates 1400, in accordance with some implementations. The present techniques for textured mesh simplification are applicable to any mesh parametrization techniques, as long as the techniques can parameterize a simplicial complex. For example, FIG. 14 illustrates texture images and an initial mesh 1410.

The initial mesh 1410 includes about 8,000 vertices. FIG. 14 illustrates a first approach to parameterizing initial mesh 1410 using a simplicial complex 1420. FIG. 14 illustrates a second approach to parameterizing initial mesh 1410 using a simplicial complex 1430. These two approaches operate in conjunction with the techniques described herein for mesh simplification, reducing the initial mesh to about 800 vertices.

FIG. 14 illustrates that both the mesh color textures and the smart UV programs can be successfully used to regenerate UV-coordinates.

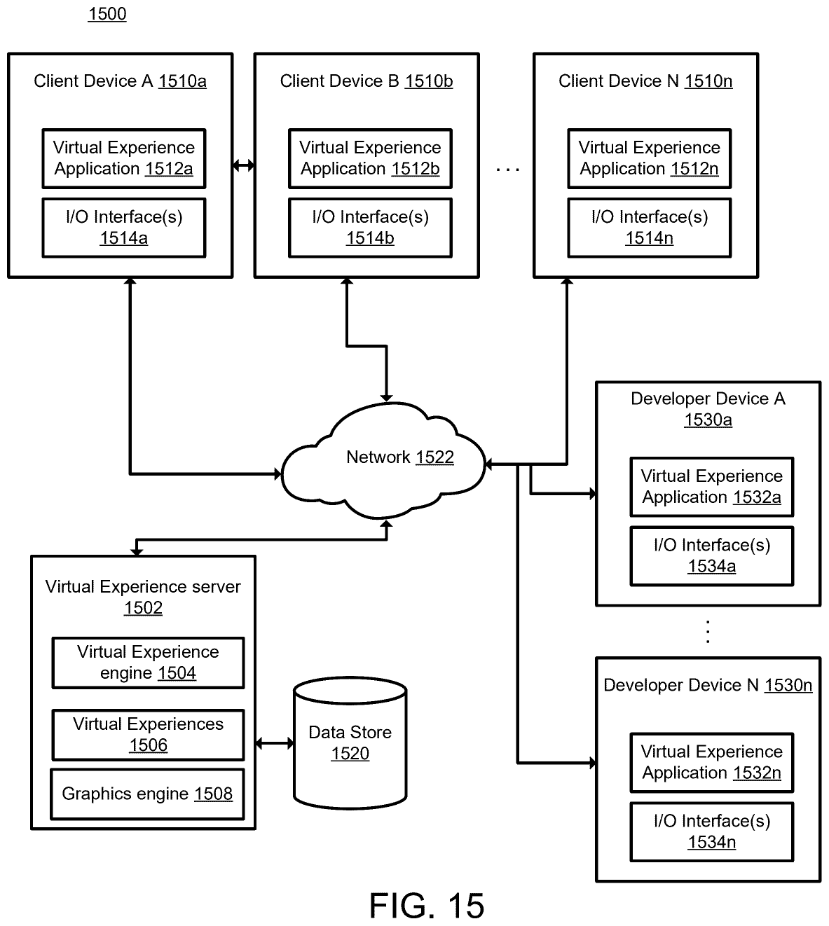

FIG. 15 is a diagram of an example system architecture that includes a 3D environment platform to simplify triangle meshes, in accordance with some implementations. FIG. 15 and the other figures use like reference numerals to identify similar elements. A letter after a reference numeral, such as “1510,” indicates that the text refers specifically to the element having that particular reference numeral. A reference numeral in the text without a following letter, such as “1510,” refers to any or all of the elements in the figures bearing that reference numeral (e.g., “1510” in the text refers to reference numerals “1510a,” “1510b,” and/or “1510n” in the figures).

The system architecture 1500 (also referred to as “system” herein) includes online virtual experience server 1502, data store 1520, client devices 1510a, 1510b, and 1510n (generally referred to as “client device(s) 1510” herein), and developer devices 1530a and 1530n (generally referred to as “developer device(s) 1530” herein). Virtual experience server 1502, data store 1520, client devices 1510, and developer devices 1530 are coupled via network 1522. In some implementations, client devices(s) 1510 and developer device(s) 1530 may refer to the same or same type of device.

Online virtual experience server 1502 can include, among other things, a virtual experience engine 1504, one or more virtual experiences 1506, and graphics engine 1508. In some implementations, the graphics engine 1508 may be a system, application, or module that permits the online virtual experience server 1502 to provide graphics and animation capability. In some implementations, the graphics engine 1508 and/or virtual experience engine 1504 may perform one or more of the operations described below in connection with the flowcharts shown in FIGS. 2A-2D. A client device 1510 can include a virtual experience application 1512, and input/output (I/O) interfaces 1514 (e.g., input/output devices). The input/output devices can include one or more of a microphone, speakers, headphones, display device, mouse, keyboard, game controller, touchscreen, virtual reality consoles, etc.

A developer device 1530 can include a virtual experience application 1532, and input/output (I/O) interfaces 1534 (e.g., input/output devices). The input/output devices can include one or more of a microphone, speakers, headphones, display device, mouse, keyboard, game controller, touchscreen, virtual reality consoles, etc.

System architecture 1500 is provided for illustration. In different implementations, the system architecture 1500 may include the same, fewer, more, or different elements configured in the same or different manner as that shown in FIG. 15.

In some implementations, network 1522 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 1520 may be a non-transitory computer readable memory (e.g., random access memory), a cache, a drive (e.g., a hard drive), a flash drive, a database system, or another type of component or device capable of storing data. The data store 1520 may also include multiple storage components (e.g., multiple drives or multiple databases) that may also span multiple computing devices (e.g., multiple server computers). In some implementations, data store 1520 may include cloud-based storage.

In some implementations, the online virtual experience server 1502 can include a server having one or more computing devices (e.g., a cloud computing system, a rackmount server, a server computer, cluster of physical servers, etc.). In some implementations, the online virtual experience server 1502 may be an independent system, may include multiple servers, or be part of another system or server.

In some implementations, the online virtual experience server 1502 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 1502 and to provide a user with access to online virtual experience server 1502. The online virtual experience server 1502 may also include a website (e.g., a web page) or application back-end software that may be used to provide a user with access to content provided by online virtual experience server 1502. For example, users may access online virtual experience server 1502 using the virtual experience application 1512 on client devices 1510.

In some implementations, virtual experience session data are generated via online virtual experience server 1502, virtual experience application 1512, and/or virtual experience application 1532, and are stored in data store 1520. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 1502 may be a type of social network providing connections between users or a type of user-generated content system that allows users (e.g., end-users or consumers) to communicate with other users on the online virtual experience server 1502, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 1520 or within virtual experiences 1506. The data store 1520 may be utilized to store chat transcripts (text, audio, images, etc.) exchanged between participants, with appropriate permissions from the players and in compliance with applicable regulations.

In some implementations, the chat transcripts are generated via virtual experience application 1512 and/or virtual experience application 1532 or and are stored in data store 1520. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 1520.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 1502 may be a virtual gaming server. For example, the gaming server may provide single-player or multiplayer games to a community of users that may access as “system” herein) includes online virtual experience server 1502, data store 1520, client or interact with virtual experiences using client devices 1510 via network 1522. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 1510) within a virtual experience (e.g., 1506) or the presentation of the interaction on a display or other output device (e.g., 1514) of a client device 1510. For example, virtual experience engagement may include interactions with one or more participants within a virtual experience or the presentation of the interactions on a display of a client device.

In some implementations, a virtual experience 1506 can include an electronic file that can be executed or loaded using software, firmware or hardware configured to present the virtual experience content (e.g., digital media item) to an entity. In some implementations, a virtual experience application 1512 may be executed and a virtual experience 1506 rendered in connection with a virtual experience engine 1504. In some implementations, a virtual experience 1506 may have a common set of rules or common goal, and the environment of a virtual experience 1506 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 1506 may be collectively referred to as a “world” or “virtual experience world” or “gaming world” or “virtual world” or “universe” herein. An example of a world may be a 3D world of a virtual experience 1506. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 1502 can host one or more virtual experiences 1506 and can permit users to interact with the virtual experiences 1506 using a virtual experience application 1512 of client devices 1510. Users of the online virtual experience server 1502 may play, create, interact with, or build virtual experiences 1506, communicate with other users, and/or create and build objects (e.g., also referred to as “item(s)” or “virtual experience objects” or “virtual experience item(s)” herein) of virtual experiences 1506.

For example, in generating user-generated virtual items, users may create characters, decoration for the characters, one or more virtual environments for an interactive virtual experience, or build structures used in a virtual experience 1506, among others. In some implementations, users may buy, sell, or trade virtual experience objects, such as in-platform currency (e.g., virtual currency), with other users of the online virtual experience server 1502. In some implementations, online virtual experience server 1502 may transmit virtual experience content to virtual experience applications (e.g., 1512). In some implementations, virtual experience content (also referred to as “content” herein) may refer to any data or software instructions (e.g., virtual experience objects, virtual experience, user information, video, images, commands, media item, etc.) associated with online virtual experience server 1502 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience 1506 of the online virtual experience server 1502 or virtual experience applications 1512 of the client devices 1510. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 1502 hosting virtual experiences 1506, is provided for purposes of illustration. In some implementations, online virtual experience server 1502 may host one or more media items that can include communication messages from one user to one or more other users. With user permission and express user consent, the online virtual experience server 1502 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 1506 may be associated with a particular user or a particular group of users (e.g., a private virtual experience), or made widely available to users with access to the online virtual experience server 1502 (e.g., a public virtual experience). In some implementations, where online virtual experience server 1502 associates one or more virtual experiences 1506 with a specific user or group of users, online virtual experience server 1502 may associate the specific user(s) with a virtual experience 1506 using user account information (e.g., a user account identifier such as username and password).

In some implementations, online virtual experience server 1502 or client devices 1510 may include a virtual experience engine 1504 or virtual experience application 1512. In some implementations, virtual experience engine 1504 may be used for the development or execution of virtual experiences 1506. For example, virtual experience engine 1504 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 1504 may generate commands that help compute and render the virtual experience (e.g., rendering commands, collision commands, physics commands, etc.) In some implementations, virtual experience applications 1512 of client devices 1510, respectively, may work independently, in collaboration with virtual experience engine 1504 of online virtual experience server 1502, or a combination of both.

In some implementations, both the online virtual experience server 1502 and client devices 1510 may execute a virtual experience engine/application (1504 and 1512, respectively). The online virtual experience server 1502 using virtual experience engine 1504 may perform some or all the virtual experience engine functions (e.g., generate physics commands, rendering commands, etc.), or offload some or all the virtual experience engine functions to virtual experience engine 1504 of client device 1510. In some implementations, each virtual experience 1506 may have a different ratio between the virtual experience engine functions that are performed on the online virtual experience server 1502 and the virtual experience engine functions that are performed on the client devices 1510. For example, the virtual experience engine 1504 of the online virtual experience server 1502 may be used to generate physics commands in cases where there is a collision between at least two virtual experience objects, while the additional virtual experience engine functionality (e.g., generate rendering commands) may be offloaded to the client device 1510. In some implementations, the ratio of virtual experience engine functions performed on the online virtual experience server 1502 and client device 1510 may be changed (e.g., dynamically) based on virtual experience engagement conditions. For example, if the number of users engaging in a particular virtual experience 1506 exceeds a threshold number, the online virtual experience server 1502 may perform one or more virtual experience engine functions that were previously performed by the client devices 1510.

For example, users may be playing a virtual experience 1506 on client devices 1510, and may send control instructions (e.g., user inputs, such as right, left, up, down, user election, or character position and velocity information, etc.) to the online virtual experience server 1502. Subsequent to receiving control instructions from the client devices 1510, the online virtual experience server 1502 may send experience instructions (e.g., position and velocity information of the characters participating in the group experience or commands, such as rendering commands, collision commands, etc.) to the client devices 1510 based on control instructions. For instance, the online virtual experience server 1502 may perform one or more logical operations (e.g., using virtual experience engine 1504) on the control instructions to generate experience instruction(s) for the client devices 1510. In other instances, online virtual experience server 1502 may pass one or more or the control instructions from one client device 1510 to other client devices (e.g., from client device 1510a to client device 1510b) participating in the virtual experience 1506. The client devices 1510 may use the experience instructions and render the virtual experience for presentation on the displays of client devices 1510.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 1502. In other implementations, the control instructions may be sent from a client device 1510 to another client device (e.g., from client device 1510b to client device 1510n), where the other client device generates experience instructions using the local virtual experience engine 1504. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 1510 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 1510 may be used.

One or more characters (also referred to as an “avatar” or “model” herein) may be associated with a user where the user may control the character to facilitate a user's interaction with the virtual experiences 1506.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 1502. In some implementations, creating, modifying, or customizing characters, other virtual experience objects, virtual experiences 1506, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 1502 may store characters created by users in the data store 1520. In some implementations, the online virtual experience server 1502 maintains a character catalog and virtual experience catalog that may be presented to users. In some implementations, the virtual experience catalog includes images of virtual experiences stored on the online virtual experience server 1502. In addition, a user may select a character (e.g., a character created by the user or other user) from the character catalog to participate in the chosen virtual experience. The character catalog includes images of characters stored on the online virtual experience server 1502. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 1502.

In some implementations, the client device(s) 1510 may each include computing devices such as personal computers (PCs), mobile devices (e.g., laptops, mobile phones, smart phones, tablet computers, or netbook computers), network-connected televisions, gaming consoles, etc. In some implementations, a client device 1510 may also be referred to as a “user device.” In some implementations, one or more client devices 1510 may connect to the online virtual experience server 1502 at any given moment. It may be noted that the number of client devices 1510 is provided as illustration. In some implementations, any number of client devices 1510 may be used.

In some implementations, each client device 1510 may include an instance of the virtual experience application 1512, respectively. In one implementation, the virtual experience application 1512 may permit users to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 1510 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 1502 as well as interact with online virtual experience server 1502 (e.g., engage in virtual experiences 1506 hosted by online virtual experience server 1502). As such, the virtual experience application may be provided to the client device(s) 1510 by the online virtual experience server 1502. In another example, the virtual experience application may be an application that is downloaded from a server.

In some implementations, each developer device 1530 may include an instance of the virtual experience application 1532, respectively. In one implementation, the virtual experience application 1532 may permit a developer user(s) to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 1530 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 1532 may be an online virtual experience server application for users to build, create, edit, upload content to the online virtual experience server 1502 as well as interact with online virtual experience server 1502 (e.g., provide and/or engage in virtual experiences 1506 hosted by online virtual experience server 1502). As such, the virtual experience application may be provided to the developer device(s) 1530 by the online virtual experience server 1502. In another example, the virtual experience application 1532 may be an application that is downloaded from a server. Virtual experience application 1532 may be configured to interact with online virtual experience server 1502 and obtain access to user credentials, user currency, etc. for one or more virtual experiences 1506 developed, hosted, or provided by a virtual experience developer.

In some implementations, a user may login to online virtual experience server 1502 via the virtual experience application. The user may access a user account by providing user account information (e.g., username and password) where the user account is associated with one or more characters available to participate in one or more virtual experiences 1506 of online virtual experience server 1502. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 1502 can also be performed by the client device(s) 1510, or a server, in other implementations if appropriate. In addition, the functionality attributed to a particular component can be performed by different or multiple components operating together. The online virtual experience server 1502 can also be accessed as a service provided to other systems or devices through suitable application programming interfaces (APIs), and thus is not limited to use in websites.

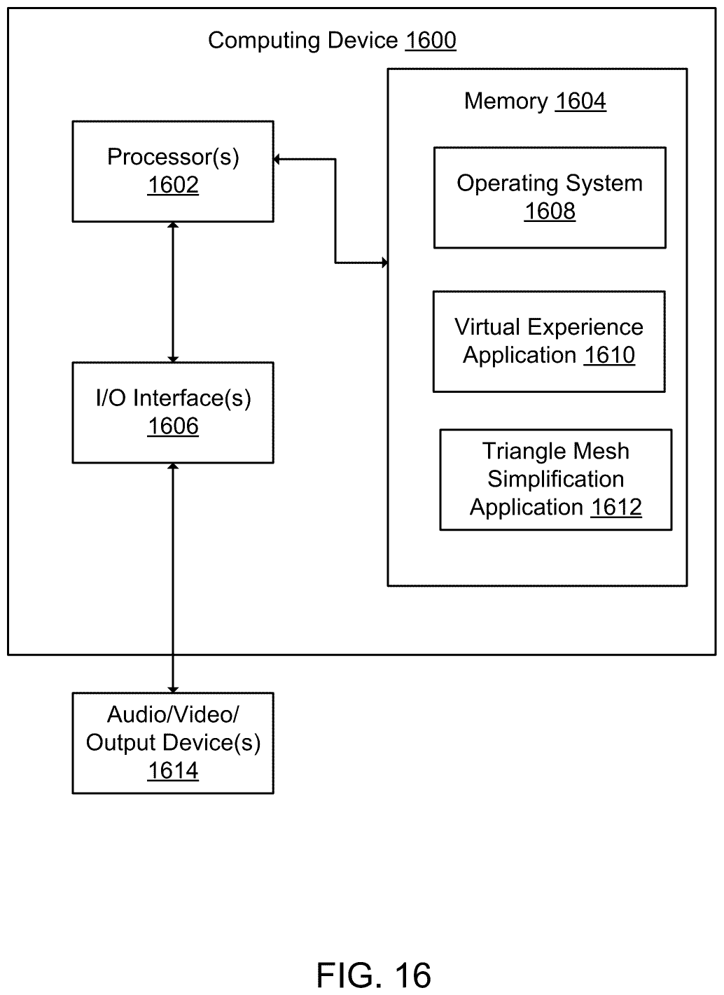

FIG. 16 is a block diagram that illustrates an example computing device 1600 which may be used to implement one or more features described herein, in accordance with some implementations. In one example, computing device 1600 may be used to implement a computer device (e.g., 1502 and/or 1510 of FIG. 15), and perform appropriate method implementations described herein. Computing device 1600 can be any suitable computer system, server, or other electronic or hardware device. For example, the computing device 1600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1600 includes a processor 1602, a memory 1604, input/output (I/O) interfaces 1606, and audio/video input/output devices 1614.

Processor 1602 can be one or more processors and/or processing circuits to execute program code and control basic operations of the computing device 1600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1604 is typically provided in computing device 1600 for access by the processor 1602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1602 and/or integrated therewith. Memory 1604 can store software operating on the computing device 1600 by the processor 1602, including an operating system 1608, a virtual experience application 1610, a triangle mesh simplification application 1612, and other applications (not shown). In some implementations, virtual experience application 1610 and/or triangle mesh simplification application 1612 can include instructions that enable processor 1602 to perform the functions (or control the functions of) described herein, e.g., some or all of the methods described with respect to FIGS. 2A-2D.

For example, virtual experience application 1610 can include a triangle mesh simplification application 1612, which as described herein can manage simplifying triangle meshes and perform related tasks within an online virtual experience server (e.g., 1502). Elements of software in memory 1604 can alternatively be stored on any other suitable storage location or computer-readable medium. In addition, memory 1604 (and/or other connected storage device(s)) can store instructions and data used in the features described herein. Memory 1604 and any other type of storage (magnetic disk, optical disk, magnetic tape, or other tangible media) can be considered “storage” or “storage devices.”

I/O interface(s) 1606 can provide functions to enable interfacing the computing device 1600 with other systems and devices. For example, network communication devices, storage devices (e.g., memory and/or data store 1520), and input/output devices can communicate via I/O interface(s) 1606. In some implementations, the I/O interface 1606 can connect to interface devices including input devices (keyboard, pointing device, touchscreen, microphone, camera, scanner, etc.) and/or output devices (display device, speaker devices, printer, motor, etc.).

The audio/video input/output devices 1614 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 16 shows one block for each of processor 1602, memory 1604, I/O interface(s) 1606, and software blocks of operating system 1608, virtual experience application 1610, and triangle mesh simplification application 1612. These blocks may represent one or more processors or processing circuitries, operating systems, memories, I/O interfaces, applications, and/or software engines. In other implementations, computing device 1600 may not have all of the components shown and/or may have other elements including other types of elements instead of, or in addition to, those shown herein. While the online virtual experience server 1502 is described as performing operations as described in some implementations herein, any suitable component or combination of components of online virtual experience server 1502 or similar system, or any suitable processor or processors associated with such a system, may perform the operations described.

A user device can also implement and/or be used with features described herein. Example user devices can be computer devices including some similar components as the computing device 1600, e.g., processor(s) 1602, memory 1604, and I/O interface(s) 1606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1614, for example, can be connected to (or included in) the computing device 1600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 200a, 200b, 200c, and 200d) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to simplify triangle meshes, the method comprising:
retrieving an initial triangle mesh;
constructing an edge list for the initial triangle mesh, wherein the edge list includes physical edges and virtual edges;
decimating the initial triangle mesh to generate a simplified triangle mesh by iteratively collapsing the edges in the edge list, the collapsing being prioritized by a quadric error metric based on a combination of an edge quadric error and an area quadric error, wherein the decimating comprises maintaining a correspondence map between points on the simplified triangle mesh and corresponding points on the initial triangle mesh; and
after the decimating, performing texture transfer based on the correspondence map to generate a texture image for the simplified triangle mesh.

2. The computer-implemented method of claim 1, wherein the initial triangle mesh corresponds to a three-dimensional (3D) virtual object in a virtual experience, and wherein the initial triangle mesh is associated with a texture used to generate the texture image, with a correspondence between the initial triangle mesh and the texture being stored as a UV map.

3. The computer-implemented method of claim 2, further comprising, after performing the texture transfer:
applying the texture image to the simplified triangle mesh; and
after the applying, causing the 3D virtual object to be displayed in the virtual experience.

4. The computer-implemented method of claim 1, wherein performing the texture transfer comprises, for each point on the texture image:
identifying a point on the simplified triangle mesh associated with the point on the texture image;
finding, based on the correspondence map, a corresponding point on the initial triangle mesh corresponding to the point on the simplified triangle mesh; and
sampling color information at the corresponding point on the initial triangle mesh to determine a color for the point on the texture image.

5. The computer-implemented method of claim 1, wherein constructing the edge list comprises defining the virtual edges by:
measuring triangle-to-triangle distances between triangles in the initial triangle mesh by identifying closest points for each pair of triangles in the initial triangle mesh;
determining that a distance between the closest points for the pair of triangles is less than a threshold;
determining that the closest points are not from same connected components for the pair of triangles; and
in response to determining that the distance is less than the threshold and the closest points are not from the same connected components, forming a virtual edge between a vertex pair that is closest to the closest points for the pair of triangles.

6. The computer-implemented method of claim 1, further comprising, after constructing the edge list, combining the edge list with initial vertices and triangles of the initial triangle mesh to form a simplicial complex.

7. The computer-implemented method of claim 6, wherein the iteratively collapsing uses greedy edge collapses to simplify a connectivity of the simplicial complex.

8. The computer-implemented method of claim 1, wherein collapsing an edge comprises:
merging a pair of vertices connected by the edge into a new vertex; and
updating the edges and faces connected to the pair of vertices by replacing references to each vertex in the pair of vertices with references to the new vertex.

9. The computer-implemented method of claim 1, further comprising performing validity checks and rejecting edges that violate the validity checks.

10. A non-transitory computer-readable medium with instructions stored thereon that, responsive to execution by a processing device, causes the processing device to perform operations comprising:
retrieving an initial triangle mesh;
constructing an edge list for the initial triangle mesh, wherein the edge list includes physical edges and virtual edges;
decimating the initial triangle mesh to generate a simplified triangle mesh by iteratively collapsing the edges in the edge list, the collapsing being prioritized by a quadric error metric based on a combination of an edge quadric error and an area quadric error, wherein the decimating comprises maintaining a correspondence map between points on the simplified triangle mesh and corresponding points on the initial triangle mesh; and
after the decimating, performing texture transfer based on the correspondence map to generate a texture image for the simplified triangle mesh.

11. The non-transitory computer-readable medium of claim 10, wherein performing the texture transfer comprises, for each point on the texture image:
identifying a point on the simplified triangle mesh associated with the point on the texture image;
finding, based on the correspondence map, a corresponding point on the initial triangle mesh corresponding to the point on the simplified triangle mesh; and
sampling color information at the corresponding point on the initial triangle mesh to determine a color for the point on the texture image.

12. The non-transitory computer-readable medium of claim 10, wherein constructing the edge list comprises defining the virtual edges by:
measuring triangle-to-triangle distances between triangles in the initial triangle mesh by identifying closest points for each pair of triangles in the initial triangle mesh; and
determining that a distance between the closest points for the pair of triangles is less than a threshold;
determining that the closest points are not from same connected components for the pair of triangles; and
in response to determining that the distance is less than the threshold and the closest points are not from the same connected components, forming a virtual edge between a vertex pair that is closest to the closest points for the pair of triangles.

13. The non-transitory computer-readable medium of claim 10, wherein the operations further comprise, after constructing the edge list, combining the edge list with initial vertices and triangles of the initial triangle mesh to form a simplicial complex.

14. The non-transitory computer-readable medium of claim 13, wherein the iteratively collapsing uses greedy edge collapses to simplify a connectivity of the simplicial complex.

15. The non-transitory computer-readable medium of claim 10, wherein collapsing an edge comprises:
merging a pair of vertices connected by the edge into a new vertex; and
updating the edges and faces connected to the pair of vertices by replacing references to each vertex in the pair of vertices with references to the new vertex.

16. A system comprising:
a memory with instructions stored thereon; and
a processing device, coupled to the memory, the processing device configured to access the memory and execute the instructions, wherein the instructions cause the processing device to perform operations comprising:
retrieving an initial triangle mesh;
constructing an edge list for the initial triangle mesh, wherein the edge list includes physical edges and virtual edges;
decimating the initial triangle mesh to generate a simplified triangle mesh by iteratively collapsing the edges in the edge list, the collapsing being prioritized by a quadric error metric based on a combination of an edge quadric error and an area quadric error, wherein the decimating comprises maintaining a correspondence map between points on the simplified triangle mesh and corresponding points on the initial triangle mesh; and
after the decimating, performing texture transfer based on the correspondence map to generate a texture image for the simplified triangle mesh.

17. The system of claim 16, wherein performing the texture transfer comprises, for each point on the texture image:
identifying a point on the simplified triangle mesh associated with the point on the texture image;
finding, based on the correspondence map, a corresponding point on the initial triangle mesh corresponding to the point on the simplified triangle mesh; and
sampling color information at the corresponding point on the initial triangle mesh to determine a color for the point on the texture image.

18. The system of claim 16, wherein constructing the edge list comprises defining the virtual edges by:
measuring triangle-to-triangle distances between triangles in the initial triangle mesh by identifying closest points for each pair of triangles in the initial triangle mesh;
determining that a distance between the closest points for the pair of triangles is less than a threshold;
determining that the closest points are not from same connected components for the pair of triangles; and
in response to determining that the distance is less than the threshold and the closest points are not from the same connected components, forming a virtual edge between a vertex pair that is closest to the closest points for the pair of triangles.

19. The system of claim 16, wherein the operations further comprise, after constructing the edge list, combining the edge list with initial vertices and triangles of the initial triangle mesh to form a simplicial complex.

20. The system of claim 19, wherein the iteratively collapsing uses greedy edge collapses to simplify a connectivity of the simplicial complex.
